(19) United States
(12) Patent Application Publication
(10) Pub. No.: US 2025/0094587 A1
(43) Pub. Date: Mar. 20, 2025

(54) SYSTEM AND METHOD FOR BEHAVIORAL ANALYSIS OF SUSPICIOUS EVENTS AND MALICIOUS APPLICATIONS IN COMPUTER SYSTEMS

(71) Applicant: Texas Tech University System, Lubbock, TX (US)

(72) Inventors: Ngoc Huyen Nguyen, Lubbock, TX (US); Tommy Dang, Lubbock, TX (US); Akbar Siami-Namin, Lubbock, TX (US)

(21) Appl. No.: 18/888,680

(22) Filed: Sep. 18, 2024

Related U.S. Application Data
(60) Provisional application No. 63/583,737, filed on Sep. 19, 2023.

(51) Int. Cl. G06F 21/56

(52) U.S. Cl. CPC G06F 21/566; G06F 2221/034

(57) ABSTRACT

A method, non-transitory computer readable medium and system comprising receiving, at a computer system, data capturing a run time behavior of a binary object, extracting, with the computer system, the data from the run time behavior of the binary object, mapping, with the computer system, the extracted data into one or more interactive visual representations of the run time behavior of the binary object comprising a scalar representation of process calls, dependencies among processes and executable files, or time dependencies between the processes and the executable files, and classifying, with the computer system, the binary object as malicious or benign.

### CROSS-REFERENCE TO RELATED APPLICATIONS

This application claims priority to U.S. Provisional Application Ser. No. 63/583,737, filed Sep. 19, 2023, the entire contents of which are incorporated herein by reference.

### STATEMENT OF FEDERALLY FUNDED RESEARCH

This invention was made with government support under Grant/Contract No. 1821560 awarded by the U.S. National Science Foundation. The government has certain rights in the invention.

### TECHNICAL FIELD OF THE INVENTION

The present invention relates in general to the field of computers, and more particularly, to a system and method for behavioral analysis of suspicious events and malicious applications in computer systems.

### BACKGROUND OF THE INVENTION

Without limiting the scope of the invention, its background is described in connection with suspicious events and malicious applications in computer systems.

Malicious software applications, or malware, are the primary source of many security problems. These intentionally manipulative malicious applications intend to perform unauthorized activities on behalf of their originators on the host machines for various reasons such as stealing advanced technologies and intellectual properties, governmental acts of revenge, and tampering sensitive information, to name a few. Malware applications are complex software programs that are often obfuscated to disguise their main intentions and thus deceive network administrators and the underlying intrusion detection systems. Although such obfuscations can be captured, reported, and maintained in a repository as a reference for building better detection mechanisms, newer malware programs are constantly developed by professional hackers raising the challenging problem of zero-day malware detection [1]. As a result, in order to build an effective malware detection and defense system, it is crucial to understand each malware and comprehend its behavior through rigorous analysis.

There are two conventional approaches that are widely adopted for analyzing software programs: 1) static analysis by which the underlying software is parsed, and intermediate transformations of the underlying software are generated without actually executing the software program. For instance, a control-flow graph can be created to represent the execution control of the program under test; and 2) dynamic analysis by which the program under test is executed in a controlled environment (e.g., a sandbox) and the behavior of the program is observed under various environmental conditions for further analysis. For instance, a sandbox (e.g., Cuckoo [2]) can capture the processes that are created along with the files that are tampered with or modified during the execution of the program under test. These two conventional program analysis techniques (i.e., static and dynamic) are often complementary to each other, each targeting different types of faults or malicious activities in the program that is being analyzed. There is also a third “hybrid” approach that enables conducting both static and dynamic analysis of the program under test.

Although these conventional program analysis techniques are shown to be effective in comprehending static and dynamic features of the software under test, it is often time-consuming, labor-intensive, and technically challenging to build a customized analysis platform. Therefore, to ease performing such a complex analysis, some other analysis techniques with a smoother learning curve and faster comprehension of functionalities of the underlying software under test should be developed for analysis purposes. The visual analytics approach is one of those possible solutions to facilitate the analysis process and efficiently and effectively showcase the processes involved in malware analysis.

Accordingly, there is a need for a system and method for behavioral analysis of suspicious events and malicious applications in computer systems.

### SUMMARY OF THE INVENTION

In one embodiment of the present disclosure, a method, comprising: receiving, at a computer system, data capturing a run time behavior of a binary object; extracting, with the computer system, the data from the run time behavior of the binary object; mapping, with the computer system, the extracted data into one or more interactive visual representations of the run time behavior of the binary object comprising a scalar representation of process calls, dependencies among processes and executable files, or time dependencies between the processes and the executable files; and classifying, with the computer system, the binary object as malicious or benign.

In one aspect, the method further comprises identifying an intention and a location of a malicious payload in the binary object. In another aspect, the method further comprises analyzing an unknown malware within the object code by recognizing one or more unusual signatures or behaviors. In another aspect, the method further comprises generating one or more rules and signatures for fully-automated malware detection systems. In another aspect, the method further comprises identifying one or more of the following: one or more indicators of compromise and malicious activities; one or more system components that are affected, tampered or damaged by the object code; how the object code functions and infects the computer system; a primary target of the object code; one or more suspicious events that occurred on a network; and an impact on the host system and its registry. In another aspect, the data capturing the run time behavior of the binary object comprises an interaction of the binary object with the host system with respect to one or more of a file system, a registry, a network, a process and a process profile. In another aspect, the method further comprises selecting the data capturing the run time behavior of the binary object. In another aspect, extracting the data from the run time behavior of the binary object comprises processing the data into a time series data and a dependency data. In another aspect, the one or more interactive visual representation of the run time behavior of the binary object further comprises: an activity overview; a network visualization; or a libraries call. In another aspect, the method further comprises zooming, with the computer system, one of the one or more interactive visual representations of the run time behavior of the binary object. In another aspect, classifying, with the computer system, the binary object as malicious or benign further comprises classifying, with the computer system, the binary object as malicious, suspicious, undetected or harmless. In another aspect, the object code contains one or more of a remote access Trojan, a Trojan, a backdoor, a ransomware, an email flooder, a behavioral malware, and a hacktool malware. In another aspect, the method further comprises: executing the binary object on a host system; and logging the data capturing the run time behavior of the binary object during execution of the binary object into a file. In another aspect, the executing and logging steps are performed by a data provider. In another aspect, the host system comprises a sandboxed system. In another aspect, the data capturing the run time behavior of the binary object comprises one or more execution traces. In another aspect, the method further comprises: filtering out one or more first functions by default system operations; or filtering out one or more second functions that are not commonly encountered by malware. In another aspect, the method further comprises: receiving an output of an anti-virus tool using an application programming interface; and incorporating the output into the one or more interactive visual representations of the run time behavior of the binary object.

In another embodiment of the present disclosure, a non-transitory computer readable medium containing a set of instructions that, when executed by a processor, cause the processor to: receive data capturing a run time behavior of a binary object; extract the data from the run time behavior of the binary object; map the extracted data into one or more interactive visual representations of the run time behavior of the binary object comprising a scalar representation of process calls, dependencies among processes and executable files, or time dependencies between the processes and the executable files; and classify the binary object as malicious or benign.

In one aspect, further comprising causing the processor to identify an intention and a location of a malicious payload in the binary object. In another aspect, further comprising causing the processor to analyze an unknown malware within the object code by recognizing one or more unusual signatures or behaviors. In another aspect, further comprising causing the processor to generate one or more rules and signatures for fully-automated malware detection systems. In another aspect, further comprising causing the processor to identify one or more of the following: one or more indicators of compromise and malicious activities; one or more system components that are affected, tampered or damaged by the object code; how the object code functions and infects the computer system; a primary target of the object code; one or more suspicious events that occurred on a network; and an impact on the host system and its registry. In another aspect, the data capturing the run time behavior of the binary object comprises an interaction of the binary object with the host system with respect to one or more of a file system, a registry, a network, a process and a process profile. In another aspect, further comprising causing the processor to select the data capturing the run time behavior of the binary object. In another aspect, extracting the data from the run time behavior of the binary object comprises processing the data into a time series data and a dependency data. In another aspect, the one or more interactive visual representation of the run time behavior of the binary object further comprises: an activity overview; a network visualization; or a libraries call. In another aspect, further comprising causing the processor to zoom one of the one or more interactive visual representations of the run time behavior of the binary object. In another aspect, causing the processor to classify the binary object as malicious or benign further comprises causing the processor to classify the binary object as malicious, suspicious, undetected or harmless. In another aspect, the object code contains one or more of a remote access Trojan, a Trojan, a backdoor, a ransomware, an email flooder, a behavioral malware, and a hacktool malware. In another aspect, further comprising causing the processor to: execute the binary object on a host system; and log the data capturing the run time behavior of the binary object during execution of the binary object into a file. In another aspect, the executing and logging steps are performed by a data provider. In another aspect, the host system comprises a sandboxed system. In another aspect, the data capturing the run time behavior of the binary object comprises one or more execution traces. In another aspect, further comprising causing the processor to: filter out one or more first functions by default system operations; or filter out one or more second functions that are not commonly encountered by malware. In another aspect, further comprising causing the processor to: receive an output of an anti-virus tool using an application programming interface; and incorporate the output into the one or more interactive visual representations of the run time behavior of the binary object.

In another embodiment of the present disclosure, a system comprises: a database; a memory; and one or more processors communicably coupled to the database and the memory, wherein the one or more processors receive data capturing a run time behavior of a binary object, extract the data from the run time behavior of the binary object, map the extracted data into one or more interactive visual representations of the run time behavior of the binary object comprising a scalar representation of process calls, dependencies among processes and executable files, or time dependencies between the processes and the executable files, and classify the binary object as malicious or benign.

In one aspect, the one or more processors identify an intention and a location of a malicious payload in the binary object. In another aspect, the one or more processors analyze an unknown malware within the object code by recognizing one or more unusual signatures or behaviors. In another aspect, the one or more processors generate one or more rules and signatures for fully-automated malware detection systems. In another aspect, the one or more processors identify one or more of the following: one or more indicators of compromise and malicious activities; one or more system components that are affected, tampered or damaged by the object code; how the object code functions and infects the computer system; a primary target of the object code; one or more suspicious events that occurred on a network; and an impact on the host system and its registry. In another aspect, the data capturing the run time behavior of the binary object comprises an interaction of the binary object with the host system with respect to one or more of a file system, a registry, a network, a process and a process profile. In another aspect, the one or more processors select the data capturing the run time behavior of the binary object. In another aspect, the one or more processors extract the data from the run time behavior of the binary object comprises the one or more processors process the data into a time series data and a dependency data. In another aspect, the one or more interactive visual representation of the run time behavior of the binary object further comprises: an activity overview; a network visualization; or a libraries call. In another aspect, the one or more processors zoom one of the one or more interactive visual representations of the run time behavior of the binary object. In another aspect, the one or more processors classify the binary object as malicious or benign further comprises the one or more processors classify the binary object as malicious, suspicious, undetected or harmless. In another aspect, the object code contains one ore more of a remote access Trojan, a Trojan, a backdoor, a ransomware, an email flooder, a behavioral malware, and a hacktool malware. In another aspect, the one or more processors: execute the binary object on a host system; and log the data capturing the run time behavior of the binary object during execution of the binary object into a file. In another aspect, the executing and logging steps are performed by a data provider. In another aspect, the host system comprises a sandboxed system. In another aspect, the data capturing the run time behavior of the binary object comprises one or more execution traces. In another aspect, the one or more processors: filter out one or more first functions by default system operations; or filter out one or more second functions that are not commonly encountered by malware. In another aspect, the one or more processors: receive an output of an anti-virus tool using an application programming interface; and incorporate the output into the one or more interactive visual representations of the run time behavior of the binary object.

Note that the invention is not limited to the embodiments described herein, instead it has the applicability beyond the embodiments described herein. The brief and detailed descriptions of this disclosure are given in the following.

### BRIEF DESCRIPTION OF THE DRAWINGS

For a more complete understanding of the features and advantages of the present invention, reference is now made to the detailed description of the invention along with the accompanying figures and in which:

FIG. 1 is a schematic overview of MalView framework for analyzing the dynamic behavior of malware in which the visualization provides linked views and supports interactive features, such as filtering, highlighting, ranking, and details-on-demand in accordance with one embodiment of the present disclosure;

FIG. 2 depicts the main views of MalView: Input and Operation Overview (A), Process Activity (B), Classification (C), Process Dependencies (D) and Libraries Matrix (E) in accordance with one embodiment of the present disclosure;

FIG. 3 depicts a MalView analysis summary of TeeracB malware on Windows in accordance with one embodiment of the present disclosure;

FIG. 4 depicts a MalView analysis summary on RAT, with the filter set on displaying the interactions with RAT only: There are multiple and repeated function calls between the process corresponding to the RAT and explorer.exe, wscript.exe and svchost.exe in accordance with one embodiment of the present disclosure;

FIG. 5 depicts a MalView visualization for a sample Trojan in accordance with one embodiment of the present disclosure;

FIG. 6 depicts Trojan MultiInjector under MalView analysis: the sequence of Process Create events generated by the malware and its interactions with other processes in the system in accordance with one embodiment of the present disclosure;

FIG. 7 depicts MalView visualization of malware Backdoor Androm on Windows 7 in which the top chart demonstrates two separate phases: the first with malware activities, ending with a call to regasm.exe (Box A) and the second with recurring patterns involving regasm.exe itself (Box B) in accordance with one embodiment of the present disclosure;

FIG. 8 depicts MalView analysis summary of ransomware WannaPeace on Windows 7 in accordance with one embodiment of the present disclosure;

FIG. 9 depicts MalView showing suspicious activities from a Behavior malware named Bladabindi in with panel (a) shows that it starts netsh.exe to modify firewall configuration and panel (b) depicts that it sets the registry values to run itself in accordance with one embodiment of the present disclosure;

FIG. 10 depicts MalView view on a Hacktool malware type called Mailpassview wherein it first creates process svchost.exe (a), the svchost.exe starts windows update.exe (b), and then windows update.exe creates pidloc.text (c) in accordance with one embodiment of the present disclosure;

FIG. 11 depicts the classification for malicious connecting domains from malware Mailpassview in accordance with one embodiment of the present disclosure;

FIG. 12 depicts MalView visualizations of the sample ransomware on (a) Windows XP, (b) Windows 7, and (c) Windows 10 in accordance with one embodiment of the present disclosure;

FIG. 13 depicts MalView visualizations of Email Flooder on (a) Windows XP, (b) Windows 7, and (c) Windows 10 in accordance with one embodiment of the present disclosure;

FIGS. 14A-14C depicts Bladabindi malware executions on different platforms: (14A) Windows XP, (14B) Windows 7, and (14C) Windows 10 in accordance with one embodiment of the present disclosure;

FIG. 15 depicts patterns of malware behavior across platforms: Bladabindi malware executions on (a) Windows XP, (b) Windows 7, and (c) Windows 10, all under focus and context technique with busy interval length of 20 seconds in accordance with one embodiment of the present disclosure;

Table 1 depicts a feature-based comparison of Anyrun [39], Hybrid and MalView;

FIG. 16 depicts a flow chart of a method in accordance with one embodiment of the present disclosure; and

FIG. 17 depicts a block diagram of a computer system in accordance with one embodiment of the present disclosure.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity but include the general class of which a specific example may be used for illustration. The terminology herein is used to describe specific embodiments of the invention, but their usage does not limit the invention, except as outlined in the claims.

Various methods are described below to provide an example of each claimed embodiment. They do not limit any claimed embodiment. Any claimed embodiment may cover methods that are different from those described above and below. The drawings and descriptions are for illustrative, rather than restrictive, purposes.

### I. Introduction

Malicious applications are usually comprehended through two major techniques, namely static and dynamic analyses. Through static analysis, a given malicious program is parsed, and some representative artifacts (e.g., control-flow graphs) are produced without any execution; whereas, the given malicious application needs to be executed when conducting dynamic analysis. These two mainstream techniques for analyzing the given software are effective in detecting certain classes of malware. More specifically, through static analysis, the patterns and signature of the malware are exposed, helping in detecting any known malicious payload hidden in or injected into the code. On the other hand, behavioral and run-time execution patterns of software are explored through dynamic analysis. To case the analysis process, a third analysis approach, known as the visual representation of the artifacts created by both static and dynamic analysis tools, would also be a supplementary asset for malware experts. This disclosure introduces MalView, an interactive visualization platform, for malware analysis by which pattern matching techniques on both signature-based and behavioral analysis artifacts can be utilized to: 1) classify malware, 2) identify the intention and location of the malicious payload in the artifacts, 3) analyze unknown malware (i.e., zero-day malware) by recognizing any unusual signature or behavior, and 4) explore the time dependencies and thus the system components affected or tampered by the underlying malware. The results of several case studies conducted show that MalView offers more features and information compared to some other visualization tools, facilitating the malware analysis process.

MalView is an analysis-oriented development to the previously created malware visualization tool [3]. MalView emphasizes comprehensive understanding from visual analytics with in-depth, multi-faceted explorations of malware behavior and scalability to multiple malware families. The result of malware triage and analysis is significantly enhanced if a provenance of software artifacts can be identified, especially when specific attributes of suspected malware are used to identify similarities to a set of known malware artifacts, as shown by Casey et al. [4]. In light of improving malware analysis utilizing malware artifacts, one embodiment provides a detailed graphical representation for malware analysis to identify: (1) indicators of compromise and malicious activities, (2) tampering, modification, and possible damages occurred on the system, (3) the mechanics of how malware functions and infect, (4) the primary target of the malware, (5) the suspicious events occurred on the network, (6) the impact on the host and its registry, and more notably (7) the time and process dependencies occurred while executing the malware, a key feature of MalView. An application and demonstration video of one embodiment of MalView can be accessed at malview.netlify.app and malview.netlify.app/video.

Malware visualization systems can be categorized into three categories: Malware forensics, Malware Comparison, and Malware Summarization [5]. The work in MalView is under Malware Forensics and Malware Comparison categories: assisting the understanding of the behavior of an individual malware sample for forensics. By exploring the characteristics and relationships between the process and its dependencies and mapping them to visual features, MalView provides an interactive and intuitive platform to comprehend malware behavior towards the ultimate goal of generating rules and signatures for fully-automated malware detection systems. To demonstrate the effectiveness of MalView in identifying and interpreting malicious and suspicious activities of malware, this disclosure reports the analysis of different families of malware namely: Remote Access Trojans (RATs), Backdoor, Ransomware, Behavioral, Email Flooder, and Hacktool. The results show that using MalView it is possible to quickly understand the main functionalities of the underlying malware without delving into a complex analysis of the static and dynamic analysis reports. In some embodiment, the MalView visualization tool visualizes the output of several dynamic and static analysis tools. The tool also integrates the output of many anti-virus tools using their Application Programming Interface (API) to provide additional insights for each malware.

While conducting the case studies and inspecting some malware families, the different behavior exhibited by the same malware on different operating system (OS) platforms was noticed. As a result, each malware was executed and inspected on three different Windows platforms: Windows XP, Windows 7, and Windows 10 in order to recognize the impact of environmental settings on malware comprehension and analysis. Even though the execution of each malware was performed in a controlled environment, it was noticed that the newer platforms of Windows operating systems (e.g., Windows 10) were creating more system and kernel-level processes making it harder to thoroughly inspect and analyze the exact flow of each malware on these recent versions of platforms. As a remedy for such problem, it is suggested to apply additional filtering mechanisms in order to analyze each malware and its processes thoroughly.

### II. Capturing Dynamic Behavior Using ProcMon

Dynamic analysis aims at studying the behavior and actions of a malware sample when it is executed. This technique analyzes malware and returns the collected information of such behavior and actions for further processing or analysis [5]. Assuming that the malicious sample does not employ any anti-forensics guards, in this disclosure, the Windows Sysinternals Process Monitor [6], or Procmon, is employed to capture the run time behavior of malware during execution. MalView visualizes the outputs and traces produced by Procmon rather than explicitly executing a given malware directly. In other embodiments, MalView could execute the malware directly or indirectly through a data provider. During the dynamic analysis of malware execution, Procmon can capture five types of events that the Windows-based malware interacts with the host system: 1) file system, 2) registry, 3) network, 4) process and 5) profiling.

While capturing dynamic behavior of malware, it is important to use a proper Procmon filtering to avoid capturing unnecessary information from the normal execution of the system. Furthermore, even when the underlying system is idle, it has numerous background processes running that can be captured by the Procmon. As a result, the authors filtered out the activities by capturing suspicious processes only represented by functions commonly encountered by malware analysts [7], [8]. Furthermore, they excluded the default system operations such as Procmon, Autoruns, Sysmon from further visualization and analysis.

### A. Data Attributes

Procmon provides records of Windows activities through the low-level system events, where thousands of events are generated every minute. The standard output in Comma Separated Value (CSV) format from Procmon is used as the primary input for visualization components in MalView. One row in the CSV log file demonstrates one specific event and comprises of these major attributes [9]:
Time of Day: The timestamp of the day when the event occurred.
Process Name: The name of the process—active executable, performing the operation.
PID: Process identifier (ID).
Operation: The name of the executing operation.
Path: The path to the target object being operated on. This field can be empty, depending on the operation/process.
Result: The result of the operation. The values for this field include success, denied, or access.
Detail: The additional notes about the event.

### B. Event Categories

The log file output from Procmon contains five major types of process activities, which are color-coded in our framework.
Registry: Events of registry operations, such as querying and enumerating keys and values.
File System: Events related to operations on local and remote storage and file systems.
Network: Network activities, including TCP and UDP.
Process: Events of process/thread, such as process creation, start, and exit.
Profiling: Events for every process in the system in terms of memory used, kernel and user time charged, output as a log for the profile.

### III. MalView: System Overview

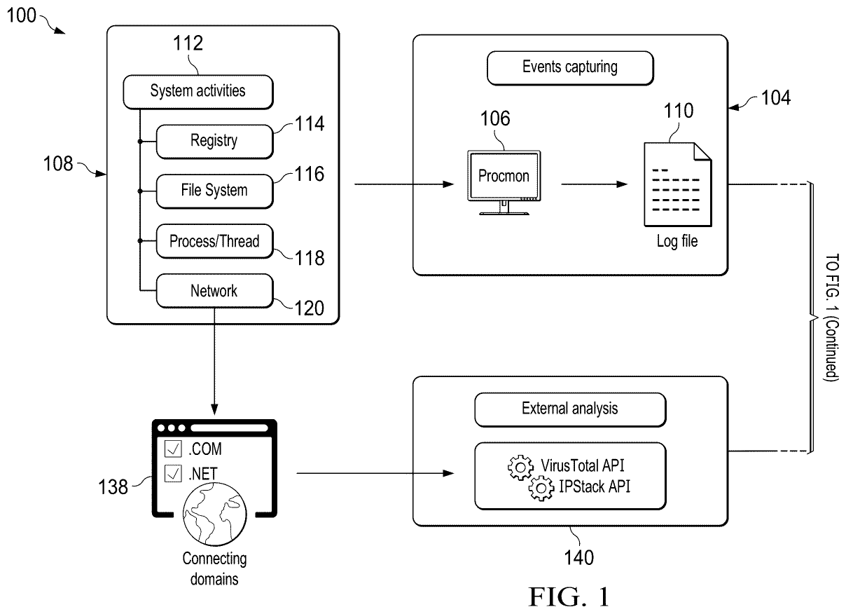

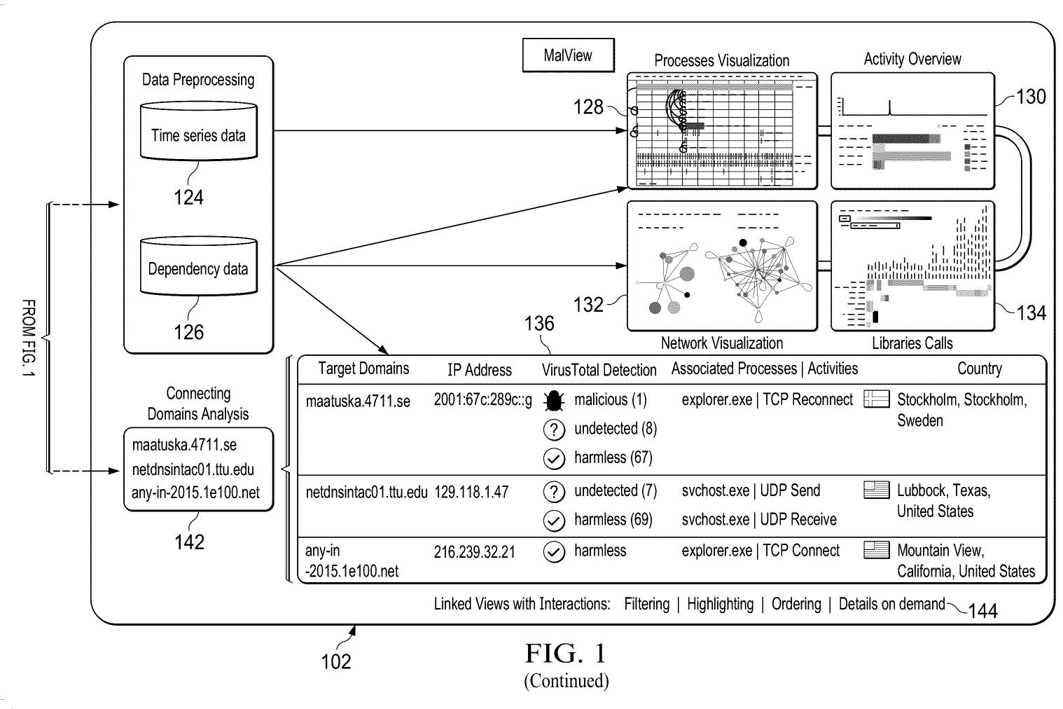

MalView is aimed at accelerating malware analysis and integrating visual analytics to enable interactive data exploration and malware behavior comprehension. FIG. 1 depicts the architecture 100 of MalView 102 in accordance with one embodiment of the present disclosure. The flow of information in MalView 102 is as follows: 1) It uses a data provider 104, such as Procmon 106, in dynamic analysis, where the malware sample is executed on a host system 108, then the data provider 104 logs relevant information into execution traces in a log file 110; 2) MalView 102 takes in the raw data captured by the data provider 104, extracts the information, and maps them to visual features; and 3) MalView 102 explores the relationship between each process and its dependencies. To the best of our knowledge, this feature has not been taken into account in previous work, not only the malware as an individual but also its interactions with the system and the artifacts created.

The MalView prototype provides visual representations for system and malware activities captured by Procmon [6] utility. In the context of malware analysis, four important system-level activities 112 are of utmost importance that need to be captured, namely registry 114, file system 116, processes and threads 118, and network activities 120. These are four major categories that are highlighted by InfoSec [7], [8] as an indication of malicious activities. The processes and events related to these four activities 112 are captured by Procmon 106, filtered, and then fed to MalView 102 where the data is preprocessed 122 into time series data 124 and dependency data 126. The processed data is then used in processes visualization 128, activity overview 130, network visualization 132, libraries calls 134, and analysis summary 136. The host system 108 may also provide data regarding connecting domains 138 for external analysis 140. The data from the external analysis 140 is provided to connecting domains analysis 142 via one or more APIs, which is then used by the analysis summary 136.

MalView 102 provides an analysis of linked views 144 with interactions for users to gain comprehensive insights into malware behaviors within the system, such as filtering, highlighting, ordering and details on demand. Details of MalView visual components with their corresponding interactive features are described in the following section, MalView: Visual components.

The tool MalView is developed as a web-based application using JavaScript and D3.js library created by M. Bostock et al. [10]. The primary goal of MalView is to provide an interactive visualization platform that demonstrates the malware behaviors and interactions within the system. The captured events are presented in multiple perspectives: in a temporal manner of processes and function calls between them, the dependency graph between a process and the objects it operates on, including registry, system files, network addresses, and dynamic-link libraries. The platform gives classification of malicious or benign connecting domains with further analysis. To meet the primary goal, MalView implements the analysis tasks below, based on the analysis task types for employing information visualization systems [11]:
T1—Provide a comprehensive overview of system activities. The visual design should present the general distribution of activities chronologically to facilitate the initial summary based on the selected malware.
T2—Display details-on-demand for activities and interactions. The user can get a close-up look at an entity or select an activity to view its event data. The system should show the information in a deeper level of supporting details that accompany the interactions among different processes.
T3—Characterize data distribution for processes and their dependencies. In addition to displaying the detailed information of processes on demands, it is also important to show the distribution of temporal patterns of processes and simultaneously use that as the context to explore their dependencies. To this end, the system should show the groupings of operated objects (e.g., dynamic-link libraries) based on their similarities in features.
T413 Present the associations: relationships among processes and function calls between a process and its dependencies. To characterize the complex associations between entities within the system, the system should show the relationships caused by interactions among processes and function calls from a process to its dependencies.
T5—Highlight critical activities in context. Here, critical is defined in context: For the timeline as a whole, MalView should allow user to zoom into the time interval that captured the most active interactions of the malware. For malware activities in particular, the system should incorporate filter-based feature to highlight the commonly encountered malicious types, besides the original representation.
T6—Order the entities based on dependencies characteristics. A specific ranking order along a data dimension be of tremendous help in the arrangement of visual components to convey important characteristics and allow the user to focus on the top essential entities.
T7—Classify malicious vs. benign activities. Another key to understand malware forensics is the ability to show the malicious and benign activities. The system should be able to classify the level of malice that corresponds with the malware sample captured.

### IV. MalView: Visual Components

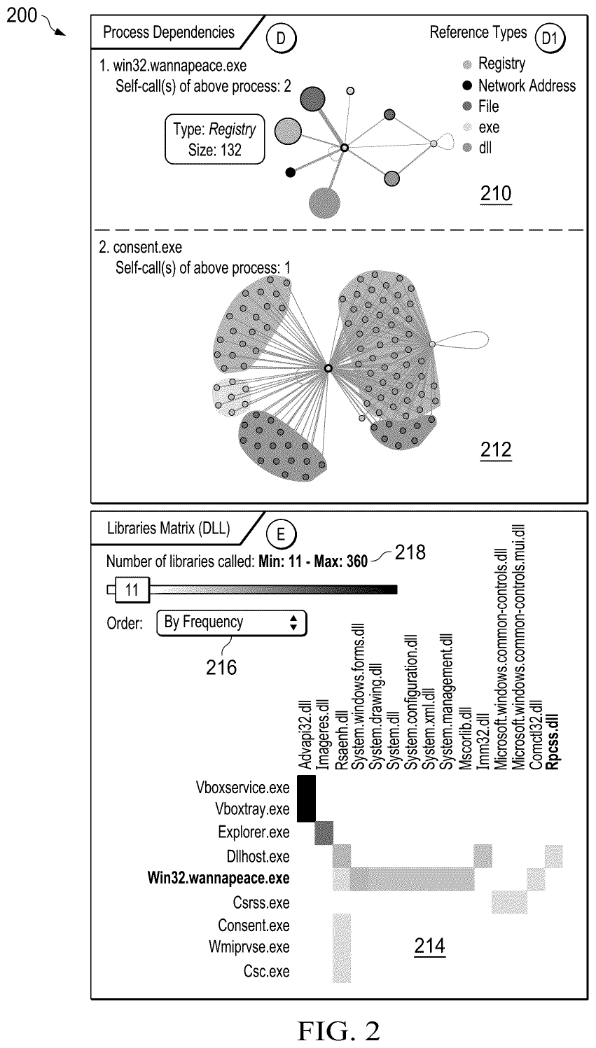

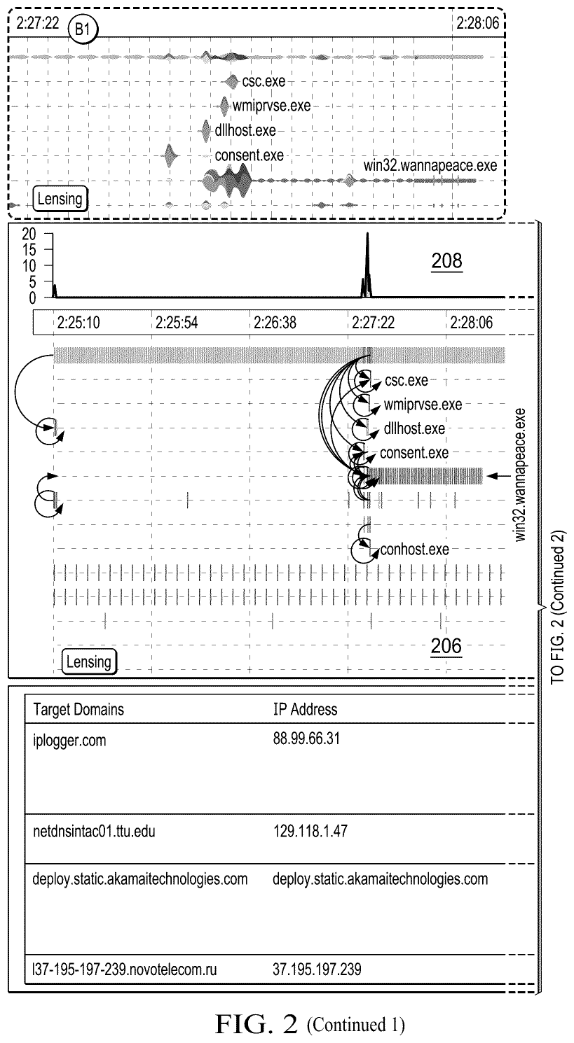

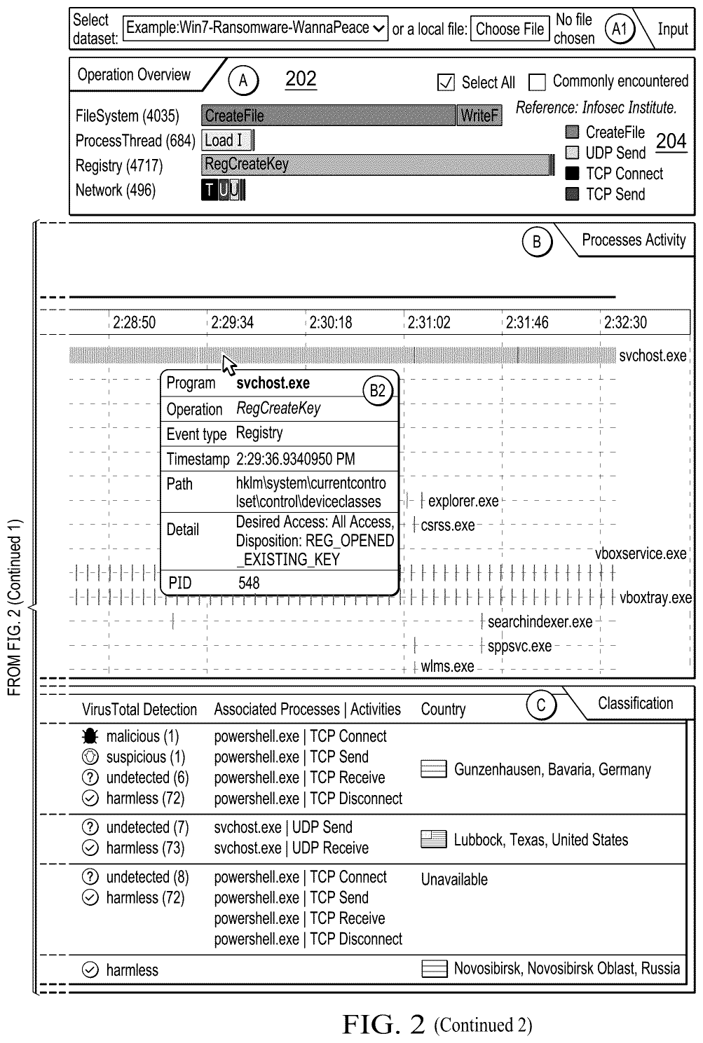

Taking into account the mapping to time, the associations between processes and dependencies, and guided by the designed tasks, the user interfaces of MalView were designed. FIG. 2 depicts the main modules 200 of MalView for supporting users in comprehension and visual reasoning of malware activities and interactions in accordance with one embodiment of the present disclosure.

### A. Input and Operation Overview

MalView provides the options for users to select input data from a default set of data samples or from their local machine, as depicted in FIG. 2, panel A1. The default dataset contains more than 60 samples of primary input data, helping users to familiarize themselves with the system and explore how the tool works. In addition to the default dataset, MalView allows users to use and analyze the output log file from running Procmon on their machine via the “Choose file” button for uploading the file for direct analysis.

After the input file is uploaded, the operation overview panel A shows how the operations are categorized and allows user to observe the prevalence of event types (visualization task T3). Each event type 202 is represented as a rectangle, stacked horizontally by its category in a bar chart visualization. There are four color hues representing four categories: yellow for File System, blue for Process and Thread, green for Registry, red for Network. The color coding employed is based on the category the event type belongs to and incorporated with the statistics of the amount of total corresponding function calls during the monitored period. An individual event type is mounted with interactivity: it acts as a button providing filtering upon mouse click, the result of which is shown directly on the below adjacent panel, processes activity panel B.

A special group of existing critical operations 204, defined by “Commonly encountered” from InfoSec [7], [8], is shown on the right of panel A, such as Create File, UDP Send, TCP Connect, TCP Send, etc. File System is mostly made up of Create File and Write File. Process Thread is mostly made up of Load Image. Registry is mostly made up of Registry Create Key. Network is mostly made up of TCP Connect, UDP Recieve and UDP Send. All the available operations captured that match the commonly encounter criteria are presented. This list serves as a selection box for highlighting critical activities in both operation overview and processes activity (visualization task T5).

### B. Temporal Patterns

Building upon the visual information mantra by Shneiderman [12]: “Overview first, zoom and filter, then details-on-demand,” the process activity in FIG. 2, panel B is designed to explore the temporal patterns from the system's low-level events along with inter-process communications. The timeline 206 is presented horizontally from left to right, while the processes are listed vertically, such as csc.exe, wmiprvse.exe, dllhost.exe, consent.exe, win32.wannapeace.exe, explorer, exe, esrss.exe, conhost.exe, vboxservice.exe, vboxtray.exe, searchindexer.exe, sppsvc.exe, wlms.exe. Besides the operations executed by a process itself, there are interactions between two processes, such as one creating the other with its primary thread, demonstrated by the arc connecting the two. On top of panel B is an area chart 208 showing the arc distribution, providing the overview of the function call frequencies (visualization task T1).

Each process is associated with an aligned set of events executed by the process itself. An individual event is represented by a thin vertical bar, color coded by its event type, which is introduced in section II-B and presented in panel A. These small, thin bars are presented with 50% transparency so that if multiple events appear at nearly the same time, the color will add up on display (visualization task T3); therefore, users can see that the calls are busy there and there is a chance for anomalies detection at these spots (visualization task T7).

The interaction arc starts from the parent process (the one that initializes the call, or the source) and ends at the child process (the destination, or the target of the call) (visualization task T4). The interactions here are the typical events of processes and thread, as specified in section II-B; hence they have the blue color of process and thread category. One of the most common events in this category is Process Create, in which a process creates a new process and its primary thread. Besides the source-target interactions, MalView also supports to visualize the call-to-self events (or the loops). In this case, the process is both the one that initializes and the target of the call.

MalView supports details-on-demand in terms of process detail, event call detail, filtering calls related to one specific process, and zooming in a period (visualization task T2). The details of an event can be shown on the tooltip by mousing over the corresponding bar, including process name, operation, event type, timestamp, process ID, and additional operation-specific information about the event, as shown in FIG. 2, panel B2. Similarly, the detail of process interaction is displayed on the tooltip by mousing over the arc, providing information on the source process, target process, and the event type of the call. For a particular process, users can choose to observe only the call originated from or to this process by a simple mouse click on that process. The zooming feature for the arc distribution (visualization task T5) will be presented with a case study in section VI-D.

### 1) Operated Objects

This processes activity panel supports the detail view by a magnification feature called “Lensing” (visualization task T2). When this feature is enabled, hovering along the timeline will expand the current window at that time step. For example, panel B1 in FIG. 2 presents the “Lensing” feature for the interval of 2:27:22 to 2:28:06. Here, the view shows another mode of presenting the referenced streamgraph rather than individual events. The event categorization revolves around five key types: registry, file system, network, process, and profiling, to determine the operated objects. Since profiling operation can be less informative about process activity and more about kernel time and memory used, profiling from the scope of the operated objects is excluded. In addition, dynamic-link libraries that contain code and data that can be used by more than one program at once are also indispensable from the analysis process. These considerations lead to the final operated object list: registry, network address, system file, exe (executable file), and dll, as shown in panel D1. That serves as a reference to both panel B1 and, later, process dependencies in panel D.

### C. Malware and Classification

FIG. 2, panel C presents the classification for malicious or benign activities of the captured log file produced by Procmon (visualization task T7). Aligning with the primary aim of providing a visual analytics tool and platform to demonstrate malware's static and dynamic behavior, MalView captures the results provided by the integrated APIs and visualizes them to the end-user. MalView incorporates a number of APIs such as VirusTotal API and inherently relies on the output produced by these APIs. The target domains that the network activities are connected to are investigated. The extracted information for each connected or targeted domain contains its Internet Protocol (IP) address, the virus detection classification results, the associated process and activities related to the domain, and lastly, the country to which the server is hosted.

The API automatically scans a given malware, and their patterns are automatically compared with more than 70 servers and databases. The virus classification result consists of four categories: malicious, suspicious, undetected, or harmless, each indicated by the number of

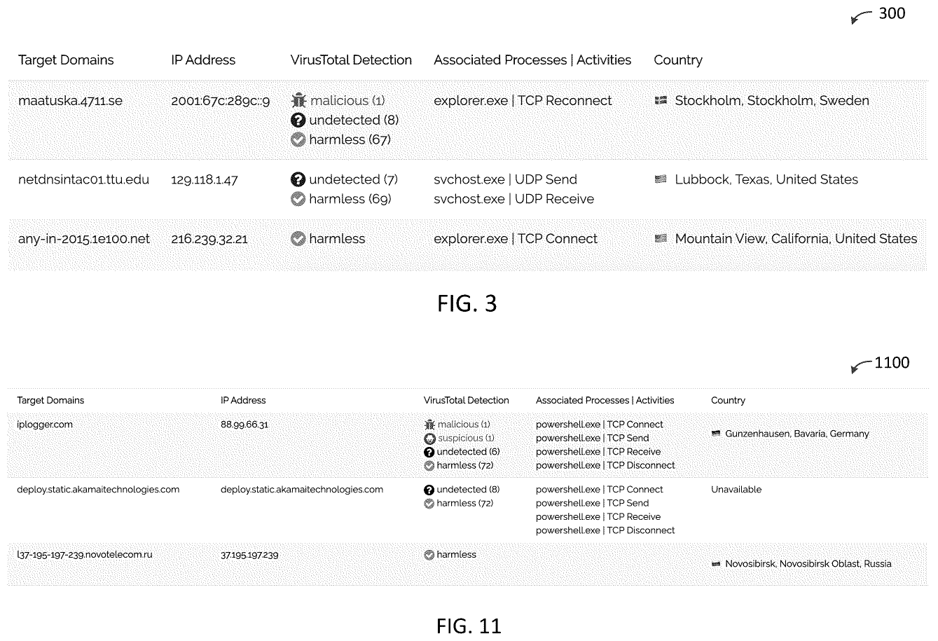

detections found corresponding to the targeted domain. Spring et al. [13] discussed that the malicious domains are attempts to connect with a command and control server or dropbox and are expected to behave differently from a typical phishing or a drive-by-download malicious site. In MalView, this list of connecting domains is ordered by the variety of the outcomes of each domain (visualization task T6). FIG. 3 demonstrates the analysis summary 300 of TeeracB malware on Windows 7 in accordance with one embodiment of the present disclosure. One malicious domain is detected, named “maatuska.4711.se”, connected by the “explorer.exe” process with “TCP Reconnect” activity.

### D. Process Dependencies

This process dependencies view in FIG. 2, panel D presents an in-depth analysis of each process in the system, where one process can operate on many types of objects, as introduced in section IV-B1 and shown in panel D1. The visualization task T4 is actualized as presenting the one-to-many relationships between the process and its dependencies. In addition, as the number of dependencies increases in cases with complex activity, a way to handle visual clutters is needed by reducing the number of visual elements while preserving the structure. For these reasons, the following are employed: 1) the force-directed layout with node-link diagram to demonstrate the relationships and 2) the node bundling technique [14] incorporated into the force-directed layout to reduce visual clutter by node aggregation. Force-directed layout has been explored in many efforts, such as [15], [16], [17], to represent the even distribution of nodes and links and speed up spring force calculations. The process dependencies panel D contains multiple windows; each corresponds to one single process, ranked by the degree of that process node (visualization task T6). In this example, the process dependencies of win32.wannapeace.exe having two self-calls are shown in the top window 210, and the process dependencies of consent.exe having one self-call are shown in the bottom window 212. In each window, aside from the main process node (positioned in the center of the graph with thick, dark stroke), each node can be in one of the two states: individual or bundling. The individual state corresponds to each node representing one object operated on by the process. The bundling state leverages the node bundling/aggregation technique [14], as shown in the top panel of panel D, where each node encompasses multiple objects with the same type and connection. The size of this bundled node is proportional to the number of the individual nodes it comprises (visualization task T3). Mouse-clicking on a bundled node transforms itself into a set of individual nodes bounded by a convex hull, as shown in the lower panel. These two states can be switched back and forth by a single mouse click on the bundled node or the convex hull surrounding the internal nodes. Besides the source-target type of connection, the graph also presents the available call-to-self events (the loops) of each process, in accordance with the processes activity panel B in FIG. 2.

### E. Libraries Matrix

FIG. 2, panel E describes the dynamic-link library (DLL) calls by each process (visualization task T4), supporting users to detect the abnormal frequency patterns (visualization task T7). These are the Windows API calls to the libraries that are part of the Windows operating system, not to be confused with the one calling VirusTotal/IPStack API for scanning connected domains, as presented in Section IV-C. System activities may involve multiple library calls from one process or a common library providing resources for various processes. To represent vast number of relationships between processes and libraries, MalView utilizes an interactive heat-map matrix 214 to prevent cluttering in contrast to conventional node-link graph visualization (visualization task T3). In the matrix 214, each cell value is color encoded by the gray color scale, in which darker presents frequent calls while lighter is rare calls. There are several criteria for ranking processes (rows)/libraries (columns) using dropdown menu 216: by similarity, frequency, or the number of different libraries called. The number of libraries called can be adjusted between 11 and 360 by using the slide bar 218.

### V. Case Studies

In an effort to provide its users with a safe and productive experience, Microsoft provides information about malware and unwanted applications affecting its operating systems online [18] and details about these in its documentation platform [19]. Microsoft [19] classifies malware into 13 categories categories: 1) Backdoor, 2) Downloader, 3) Dropper, 4) Exploit, 5) Hacktool, 6) Macro virus, 7) Obfuscator, 8) Password Stealer, 9) Ransomware, 10) Rogue security software, 11) Trojan, 12) Trojan clicker, and 13) Worm. Furthermore, Microsoft also provides a tool to search for current cyber threats, viruses, and malware in its online platform called Microsoft Security Intelligence (MSI) platform [20].

MalView can be utilized in different settings. 1) When the objective is to comprehend malware functionalities and not detection, 2) when a new malware application (zero-day malware) is developed and not detectable by any tool (due to lack of profiles and signatures), 3) when the objective is to classify a family of malware and then employ a set of generic solutions and remedies to address each class of malware, and 4) when new malware is developed, and we are interested in investigating whether it follows some existing known malicious patterns or not (i.e., labeling malware type). Accordingly, if there is an incident report about zero-day vulnerability where there is no clear patching solution developed, MalView can help analyze and comprehend the malware with zero-day vulnerability and thus enable the identification of patches or solutions better. To demonstrate the usability of MalView in analyzing malware software visually, a set of case studies were conducted in which the output and behavior of the selected malware were captured. Due to the space limit, the processes involved in seven malware were captured and presented, namely 1) Backdoor, 2) Remote Access, 3) Behaviour, 4) Ransomware, 5) Email Flooder, 6) Hacktool, and 7) Trojan (Info stealer). The following sections demonstrate the applications of MalView to several of these malware types.

### A. Experimental Setup

The malware experimentation setup needs an isolated and controlled environment so that the malicious code does not propagate or infect other entities in the network. This clean and isolated environment also helps to identify the changes and possible tampers in the system due to the malicious activities of the malware specimen. For this work, three different Windows systems were installed on an Oracle Virtual Box: Windows XP, Windows 7, and Windows 10. The windows defender services, windows security services, firewalls, and other automatic security updates were disabled on each of the virtual OSs to prevent any interruption during the malware sample's execution and capture all the traces of their dynamic behavior. To capture the interaction between the malware and each host system, Procmon was installed on all environments. More specifically, all the user applications on the virtual OS were closed, the malware process name was added to the monitor filter to capture only the events of the malware executable. Then the executable was run for two minutes before saving the time-ordered system activities from Procmon and fed to MalView.

Since MalView depends on the output of Procmon, the amount of information it visualizes depends on how long Procmon is executed. The execution time also shortens the amount of data captured by Procmon. According to experience with MalView, a larger and more complex output and traces produced by Procmon makes MalView less effective since the visualization needs to capture a vast number of processes and events. However, a key feature of MalView is to offer different levels of abstraction and complexity. If the window width (interface size) is adjusted and the sample rerun, the visual components would readjust to fit the new window size. More specifically, the execution time depends on how large the malware sample is, ranging from 0.3 s to several seconds.

### B. Remote Access Trojan (RAT)

Remote Access Tools are useful applications to provide administrative assistance to the end-users remotely. However, these pieces of software are increasingly abused by adversaries to gain control over the target systems and are referred to as Remote Access Trojans (RATs). RATs are distributed through email attachments or as a patch with pirated software to infect the target in order to gain administrative control. Once the target machines are infected, RATs have complete control over the victim system to perform malicious activities, such as password sniffing, keylogging, track file transfer information, webcam feed, control the system by issuing shell commands, or even propagate some other malwares/viruses. RATs are particularly hard to detect, as they execute legitimate operating system processes resembling the behavior of other commercial remote access tools, and they usually do not show up as running tasks. Besides, there are tools that enable performing obfuscation on a given application and produce obfuscated malicious applications. Using various obfuscation methods, along with managing resource utilization, RATs can remain undetected. According to the October 2018 Global Threat Index published by Check Point, RATs are ranked among the top 10 “most wanted” malware.

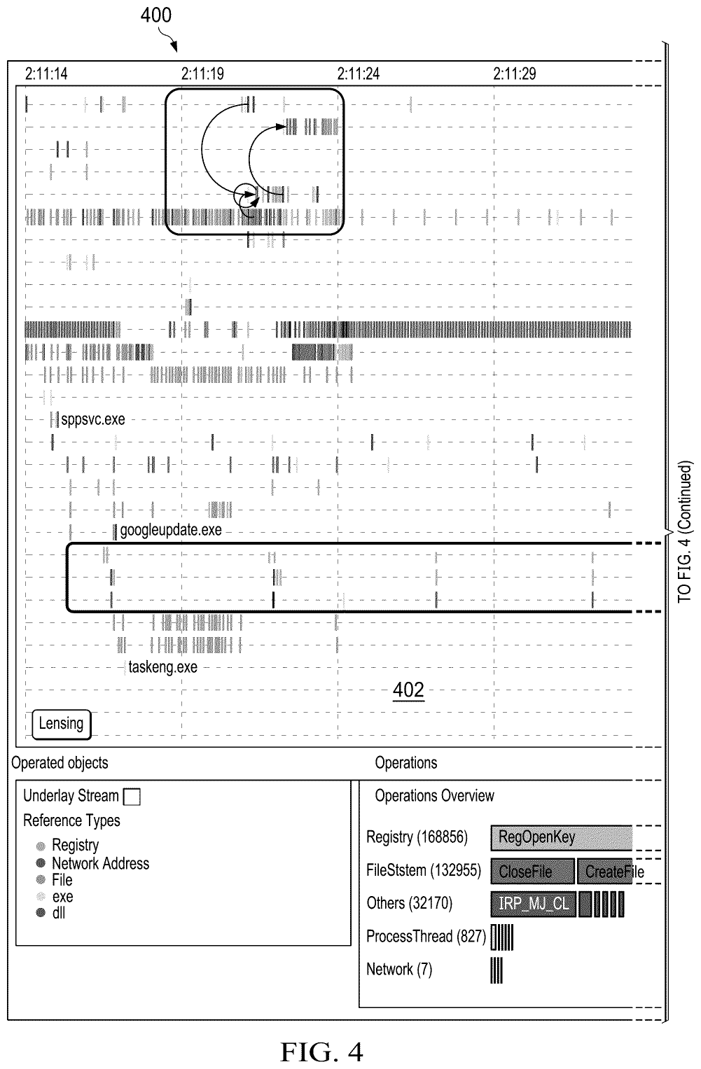

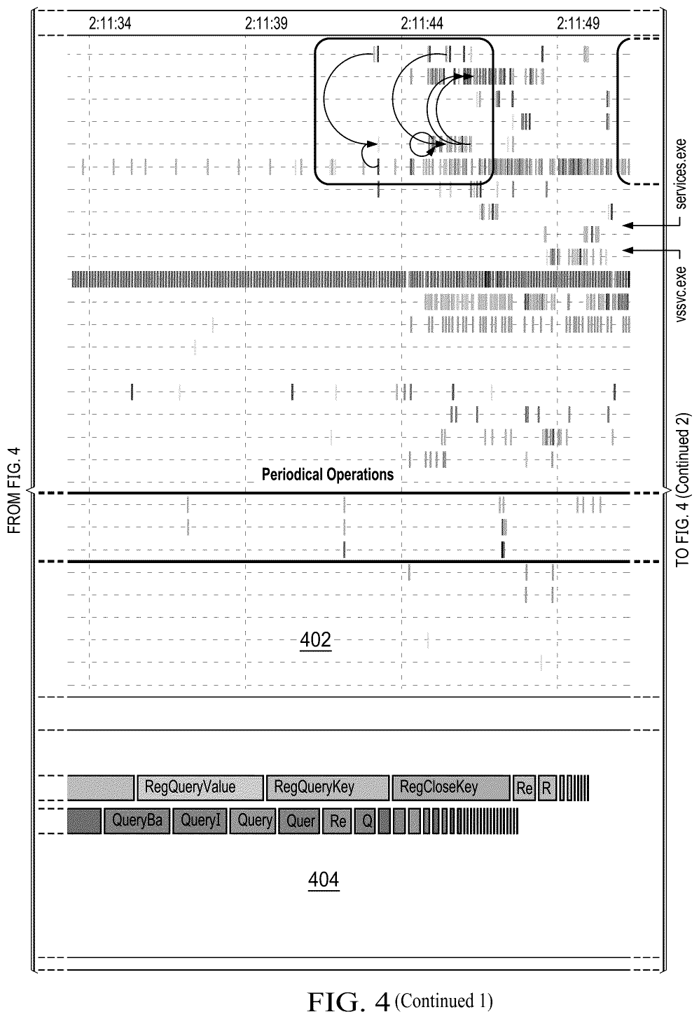

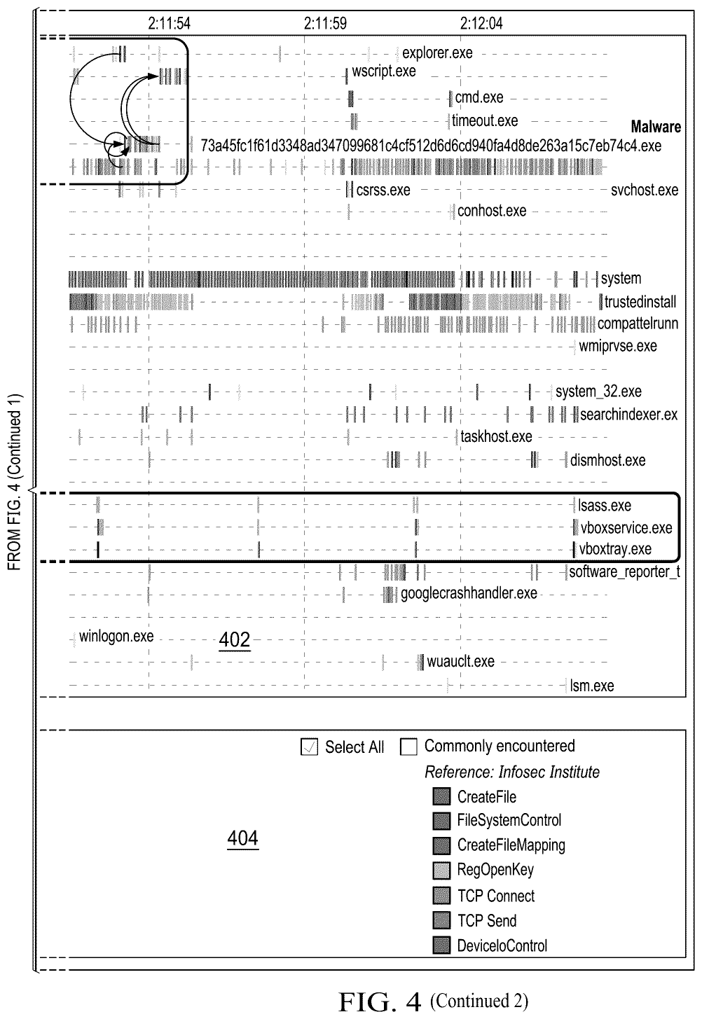

The run time behavior of RATs was captured on different Windows and visualized using visualization tool MalView. The live malware sample was downloaded from public malware dataset VirusShare [22]. According to a multi-scan report from Virustotal [23], this sample has a community score of 66 out of 70, i.e., out of 70 detection engines, 66 could identify it as a malicious executable. FIG. 4 shows the detail analysis 400 performed on an RAT sample using MalView in accordance with one embodiment of the present disclosure. The malicious indicators presented by MalView are as follows:
Process: The malicious executable spawns processes like explorer.exe, wscript.exe, and svchost.exe as shown in window 402, which displays information in a similar manner to the timeline 206 in FIG. 2. The execution of these processes indicates that the RAT program is trying to start a command prompt and then run some scripts to start a session to monitor the process remotely.
Registry: The sample RAT performs a large number of registry operations, including the creation of registry keys as well as a query of the registry entries, as shown in window 404, which display information in a similar manner as panel A in FIG. 2.
Files: The malicious PE performs a large number of various file operations, including the creation of new files and mapping file systems.
Network activity: The sample RAT does not demonstrate any significant number of TCP/UDP requests.

Besides the malware-associated events, MalView is also able to capture the recurrent pattern of periodical operations, such as the system process of Local Security Authority Subsystem Service lsass.exe or Virtual Box's vboxservice.exe. The influence of running platform will be discussed further in Section VI.

### C. Trojans

A Trojan is a type of malware that pretends to be a benign program, but after installation, it executes hidden code and then performs malicious activities such as deleting or tampering with data, stealing information, running some other scripts, and creating backdoors. In general, it enables the attacker to access the victim's system, and these types of malware are not able to replicate themselves [24].

### 1) Sample Trojan

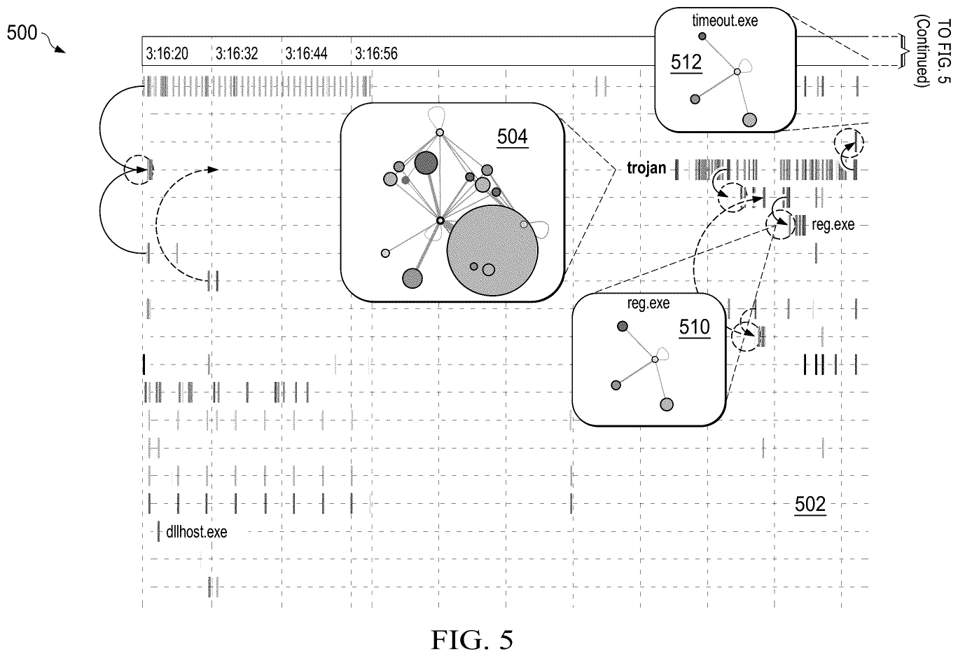

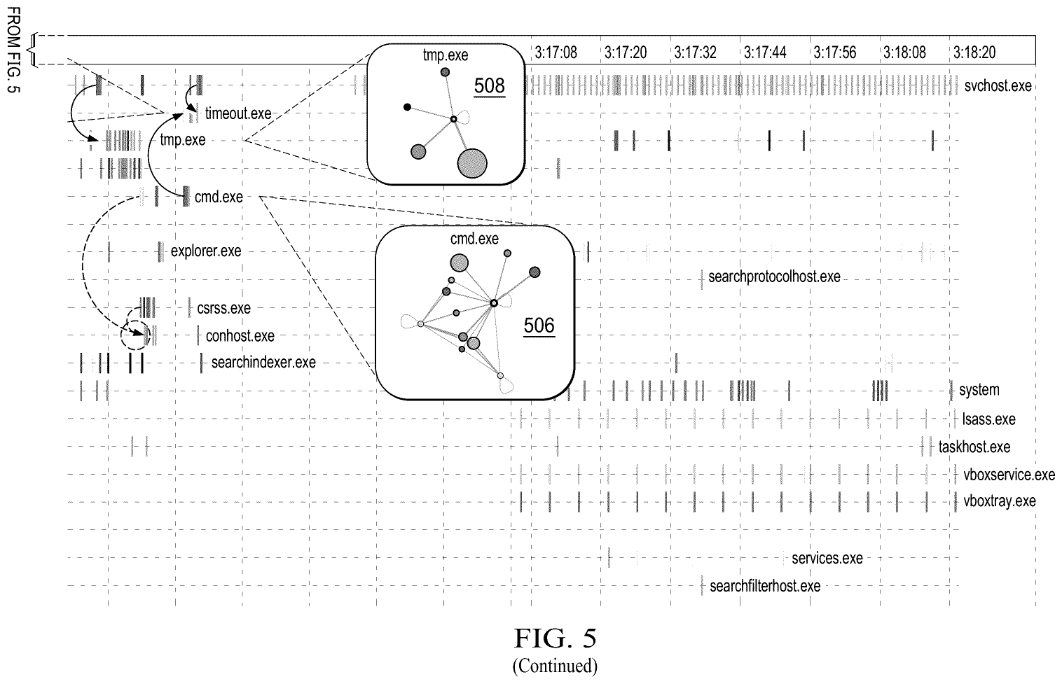

A sample of Trojan (MD5: b3eebe51ccc4a95815ddef3ef55604d2) was obtained from VirusShare [22]. The output file containing all the processes was created after running the malware in a controlled environment using Windows 7 as its platform. FIG. 5 shows the MalView output 500 for this malware in accordance with one embodiment of the present disclosure. Lensing was applied on the critical period to view the activity details. Four important processes were chosen based on the dependencies, including cmd.exe, tmp.exe, reg.exe, and timeout.exe.

By clicking the name of this malware on MalView Process Activity window 502, one can observe the file dependencies in dependency graph 504 and that this executable file has created two processes: cmd.exe and tmp.exe (at the blue links). By further clicking on the child process, one can retrieve the list of processes created by cmd.exe and tmp.exe. Then, the cmd.exe process has created two child processes: reg.exe and timeout.exe. The tmp.exe process did not create any child process. The process networks of cmd.exe, tmp.exe, reg.exe, and timeout.exe are overlaid on top of the process timeline on request as shown in dependency graph 506, 508, 510 and 512, respectively.

### 2) Trojan MultiInjector

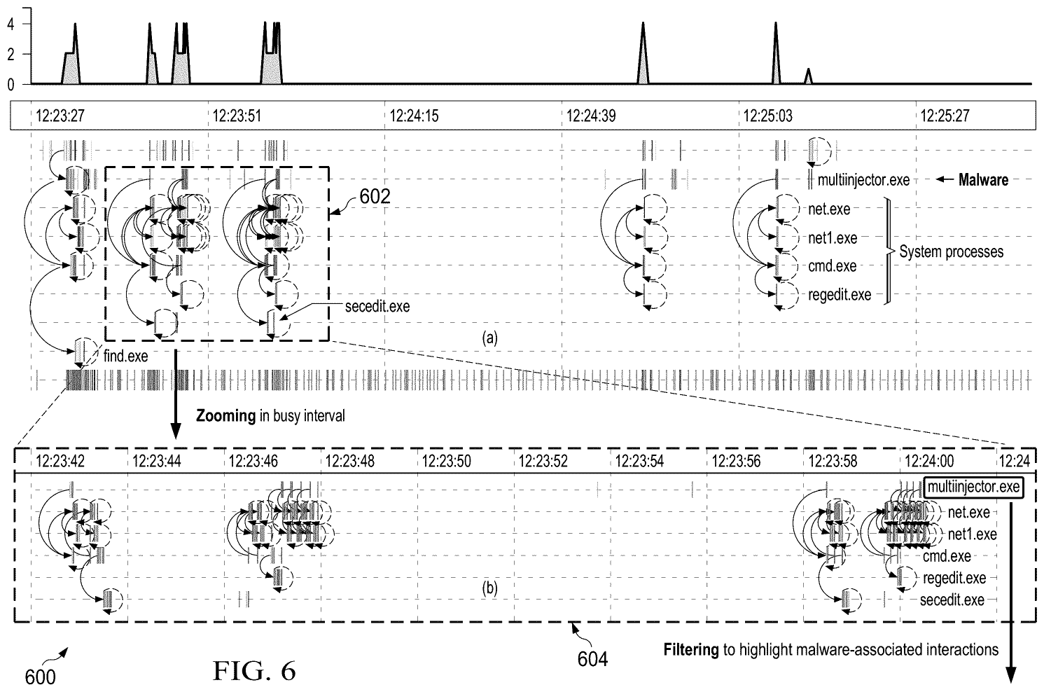

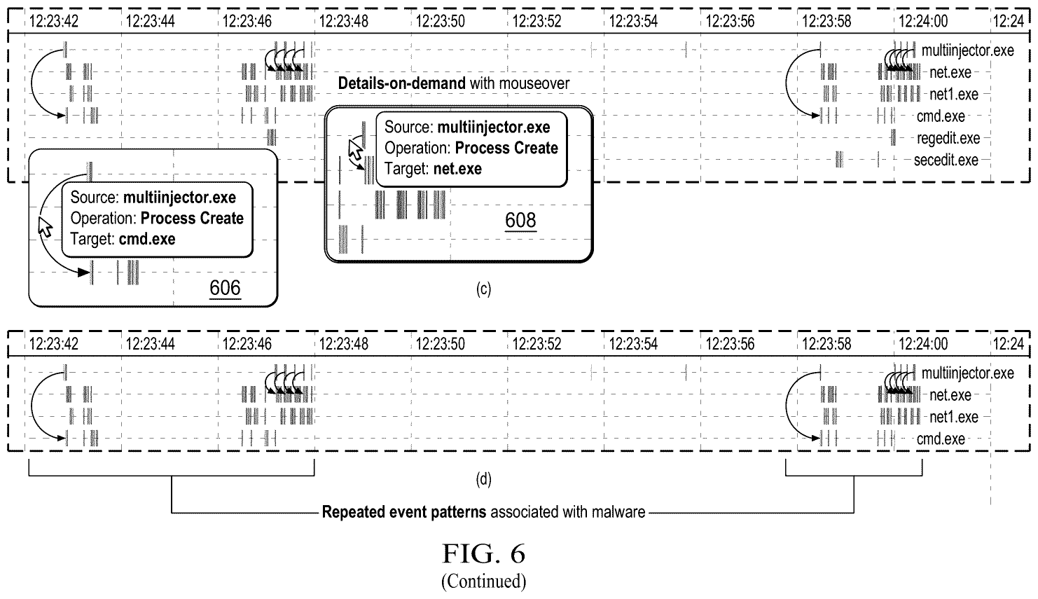

MultiInjector, under trojan classification, is a trojan that tries to inject code into other processes to hide or execute its payload and download and install other malware [25]. FIG. 6 presents a sample of trojan MultiInjector under MalView analysis in accordance with one embodiment of the present disclosure. Panel (a) presents a sample of trojan MultiInjector under MalView analysis. MalView reveals the sequence of Process Create events generated by the malware and its interactions with other processes in the system, with multiple recurring patterns of function calls. Panel (b) shows the result of zooming into the most active/busy interval 602 that was automatically detected by the tool, while panel (c) presents the outcome from filtering to highlight only interactions associated with the malware 604 with details-on-demand with mouse over as shown in windows 606 and 608. The final result patterns are shown in panel (d).

By exploring details-on-demand via mousing over, as shown in panel (c), the first event in this sequence as shown in window 606 is Process Create from the malware to cmd.exe leading to the subsequent calls. Around 12:23:47, the second event in this sequence as shown in window 608 there are four consecutive Process Create calls from the malware to net.exe. The subsequent calls can be seen in panel (b) and panel (a) (for a broad view). Finally, the repeated event patterns associated with malware are clear in panel (d): one Process Create event from the malware to cmd.exe, followed by the four subsequences to net.exe. The behavior from this observation aligns with the characteristics of the malware of injecting code into other processes. The visualization helps to discern these low-level operations from the malware to other system processes.

### D. Backdoor

A backdoor is a type of malware that provides unauthorized remote access to the compromised system by exploiting security vulnerabilities. The malware works in the background while hiding from the user. Meanwhile, it enables the attacker to have access to the victim's computer, such as databases and file servers, as well as running system-level commands. The process of injecting Backdoor is usually performed in two stages: First, a small file, called a dropper, is installed. Second, the dropper downloads the main malicious file from a remote location [26]. It is important to mention that Trojan and backdoor malwares are not the same: A Trojan might contain a backdoor, but a backdoor can execute as a stand-alone program without being a part of a Trojan.

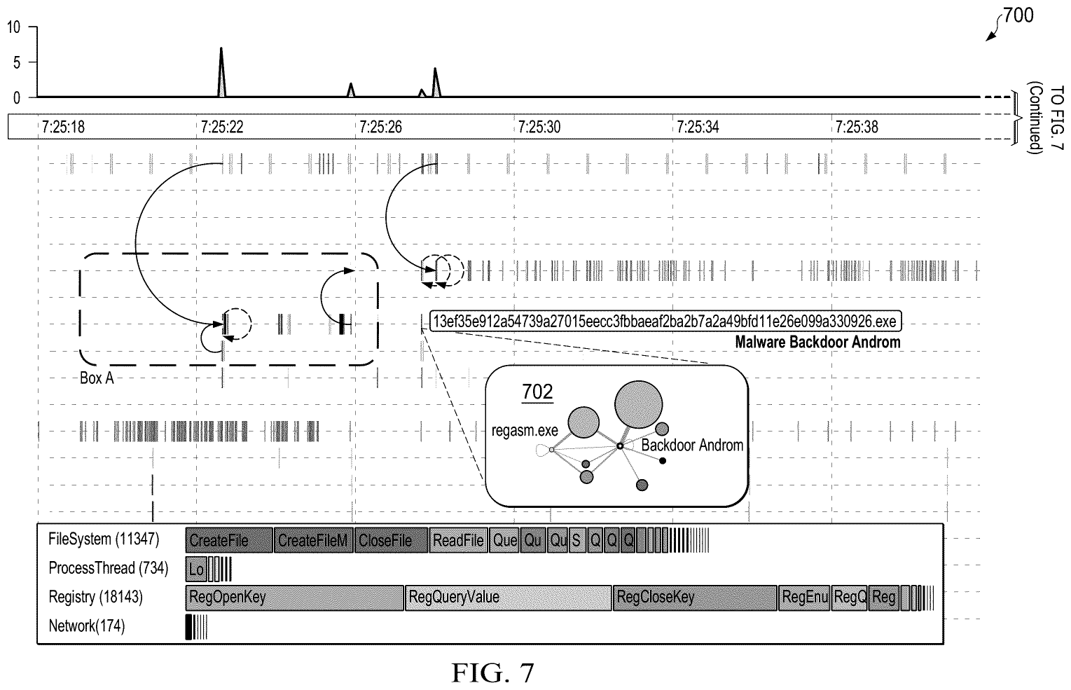

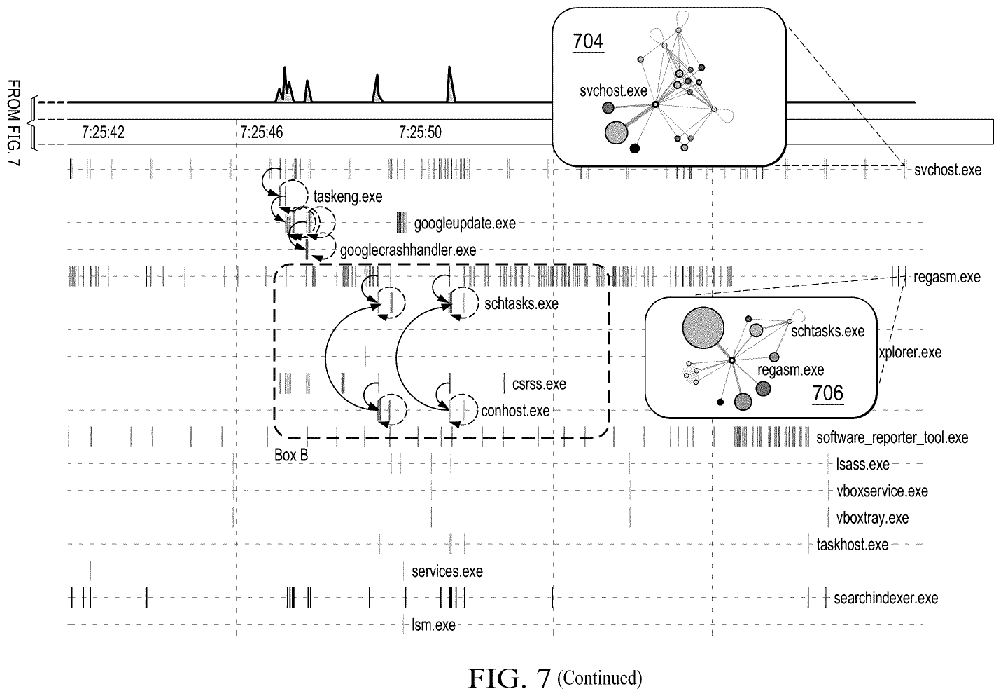

The MalView visualization 700 of malware Backdoor Androm execution on Windows 7 is presented in FIG. 7 in accordance with one embodiment of the present disclosure. The accumulation of interactions presented in the top area chart divides the observation into two phases. The first phase heavily involves activities associated with the malware and svchost.exe. The last function call from the malware is to regasm.exe (at the end of Box A), followed by an interesting recurring pattern in the second phase, as highlighted in Box B. This recurring pattern starts with a function call from regasm.exe itself to schtasks.exe, where the time between the two patterns is about two seconds. Here, process regasm.exe is the assembly registration tool, which reads metadata within an assembly and adds necessary entries to the registry.

The overlay dependency graphs in FIG. 7 open up several interesting findings. First, although its activities end early during the observation, the malware operates on multiple registry files, as shown by the large size of the green registry nodes shown in dependency graph 702. Second, svchost.exe has a long sequence of periodic operations on registry files and operates on numerous types of objects, as seen on the dependency graph 704. As the generic host process for Win32 services, it also makes function calls to the malware process twice, about five seconds apart. Finally, while regasm.exe interacts with five other processes, it only shares dependencies with schtasks.exe as shown in dependency graph 706. The dependency graphs and process activity timeline are complementary and can effectively support the analytical reasoning of malware behaviors.

### E. Ransomware

A typical ransomware program encrypts the victims' computer files and demands a ransom to restore access to the data. A ransomware program locks a system, utilizes some visual messages, imposing law enforcement to threaten the target. The ransomware scam has matured over time, utilizing different methods to impair a computer. According to a report published by Symantec [27], the latest advancement prevents the computer from functioning and dismisses the

client from gaining any access. The system at such a stage displays a message that proclaims to be from a local law enforcement organization. The ransomware application asks for money in exchange for letting the users re-gain access to their systems. In recent news in July 2021 by Malwarebytes report [28], a severe ransomware attack was reportedly taking place against the popular Remote Monitoring and Management software tool Kaseya VSA. This attack forced an immediate shut down of the VSA servers, where Kaseya VSA was used to encrypt over 1,000 businesses. The attackers asked for $70M in exchange for a universal decryptor. Also reported by Malwarebytes [29], 35% of small and medium-sized businesses were under attack of ransomware. A lot of times, these organizations end up paying for the ransom. According to a multi-scan report from Virustotal, the sample studied in this paper has a community score of 47 out of 72, i.e., out of 72 detection engines, 47 could identify it as a malicious executable.

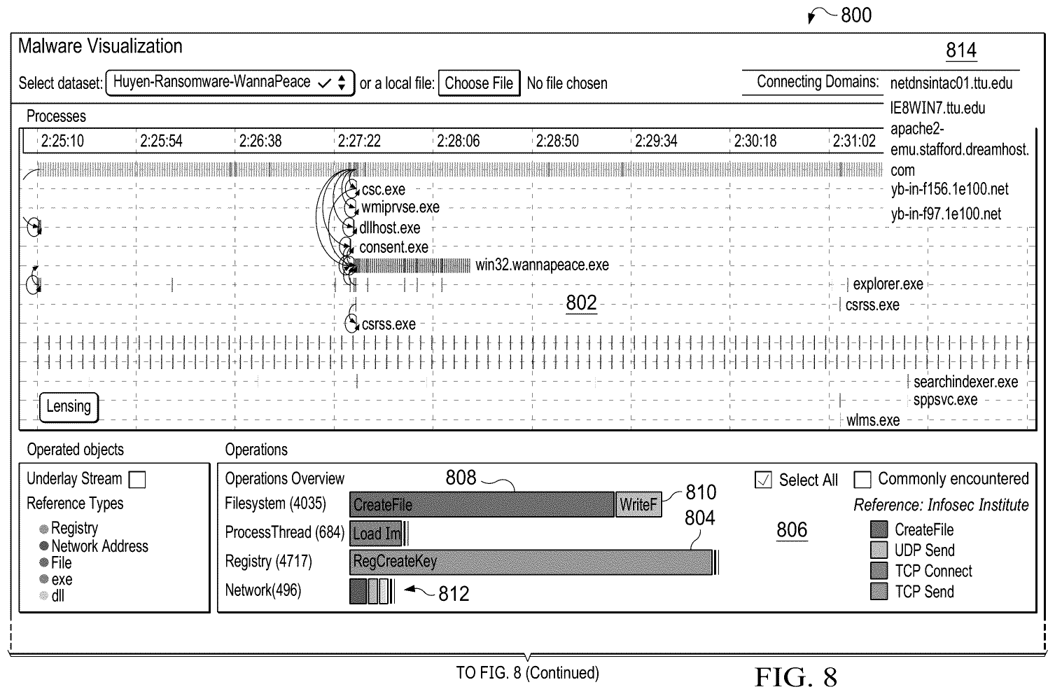

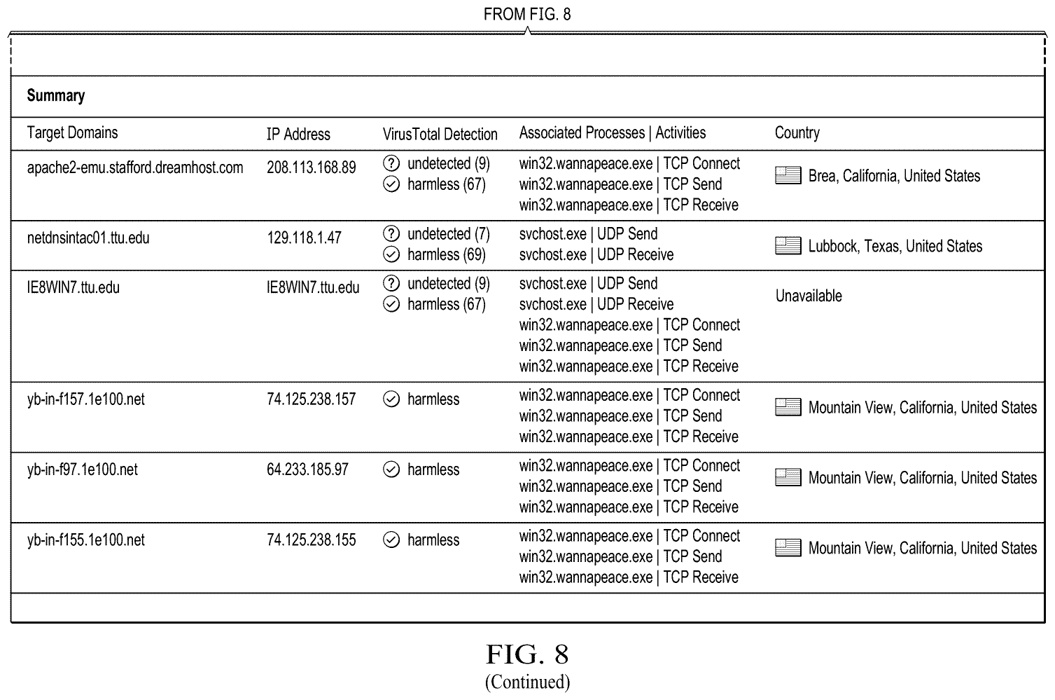

FIG. 8 shows the visualization 800 for the dynamic activities of the ransomware wannapeace.exe (MD5: eefa6f98681d78b63f15d7e58934c6cc) in accordance with one embodiment of the present disclosure. The malicious indicators presented by the MalView are as follows:
Processes: The time window 802 shows that the ransomware spawns: conhost.exe and consent.exe. The conhost.exe indicates that the ransomware is accessing the command line, whereas the consent.exe is an indicator that the program is trying to utilize the user access.
Registry: It creates a registry key to make changes as shown by the green bar 804 in the operations window 806.
Files: Malicious PE performs a lot of file operations. For instance, it performs 3434 times of CreateFile operations and 601 times of WriteFile operations as shown by the orange bar 808 and yellow bar 810, respectively.
Network activity: The malware performs many TCP/UDP connection requests, sends, and receives as shown in the colored bars 812.
Domain Activity: It connects to seven different domains, as shown on the upper right corner 814.

### F. Behavioral Malware

At the time of this writing, a search on Microsoft Security Intelligence threat search platform [20] returned 500 malware as Behavior type, in which the distribution of alert levels was as 400, 38, 3, and 16 for severe, high, moderate, and low, respectively. A behavior type of malware generally includes malware that exhibits suspicious activities, but it is not classified into a specific popular category of malware. This type of malware is difficult to detect because its activities can greatly vary depending on the intention of the underlying malware and the current user context. Our study of several malwares in “Behavior” type shows that these suspicious activities include 1) disabling system recovery, 2) deleting shadow copies, 3) hidden code executions, 4) creating files in the user's system, 5) changing the registry key to run itself, and 6) accessing to netsh.exe to modify firewall configuration that allows itself to run on system startup. Examples of such behavioral malware include Bladabindi.gen [30], Vawtrak.A [31], and Teerac.B [32]. Furthermore, some behavioral malware (e.g., MultiInjector [33]) involves accessing the command prompt (CMD).

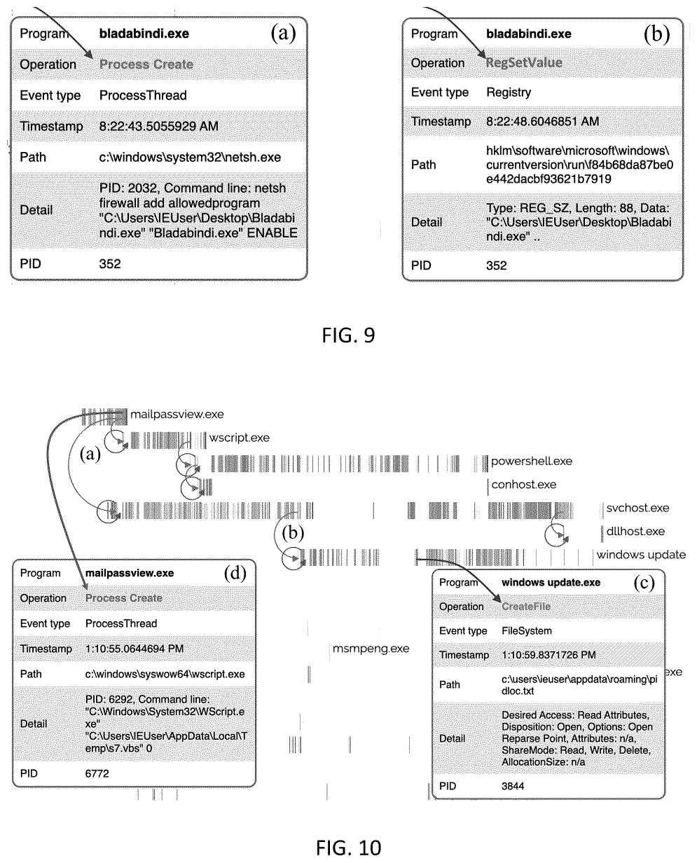

For instance, FIG. 9 shows suspicious activities from an example of the Behavior malware type called Bladabindi in accordance with one embodiment of the present disclosure. Panel (a) shows that it starts netsh.exe to modify firewall configuration to add itself as a permissible program. Panel (b) provides a piece of evidence as it sets the registry value (RegSetValue) on the user system to runs itself at Windows Startup for the same malware.

### G. Hacktool Malware

Hacktool is a piece of software that malicious attackers use to gain unauthorized access to user's devices [18]. As of the time of this writing, Microsoft lists 188 active entries as Hacktools, of which 93 are severe, 80 are high, and 15 are moderate in terms of alert levels [20]. The popular attacking channel for Hacktool is via insecure Universal Serial Bus (USB) communication design and Windows Autoplay features [34]. Malicious activities for Hacktool launched from USB include 1) changing registry settings, 2) installing a backdoor, 3) stealing confidential information, and 4) reading data encryption keys. Recently, besides Trojan, Hacktool is also the second most prevalent type of malware embedded in pirated software [35].

FIG. 10 shows MalView view while analyzing a sample of Hacktool malware type named Mailpassview [36] in accordance with one embodiment of the present disclosure. It first creates svchost.exe process indicated by (a). The svchost.exe process then creates windows update.exe indicated by (b). This process then creates several files like holdermail.txt (via using vcb.exe) to store “Browser Password Recovery Report,” pidloc.txt to contain information of compromised computers (panel (c)). These are the pieces of evidence about the existence of Hawkeye Keylogger [37] to steal sensitive data (e.g., email password).

Determining whether the connecting domains from network activities are malicious or benign is important. The classification 1100 for malicious connecting domain for the malware Mailpassview is shown is FIG. 11 in accordance with one embodiment of the present disclosure. Among the examined domains, the target domain iplogger.com is assessed as malicious and suspicious by VirusTotal, with the IP address 88.99.66.31 from Gunzenhausen, Bavaria, Germany. Recall from the chained calls shown in FIG. 10: The process corresponding to the malware mailpassview.exe called and initiated wscript.exe with Process Create (panel (d) in FIG. 10), then wscript.exe also called and initiated powershell.exe with Process Create. This chain continues with process powershell.exe connecting to malicious target domain iplogger.com with four different activities: TCP Connect, TCP Send, TCP Receive and TCP Disconnect. Here, wscript.exe is stored in C:\Windows\System32 and provides an environment in which users can execute scripts, which is different from the malicious programs that malware programmers or cyber criminals write and name it as wscript.exe.

### VI. The Influence of Running Platforms on Malware Behavior

To examine how malware behaves in different platforms, multiple malware were executed on Microsoft's mainstream Windows OSs.

### A. Ransomware

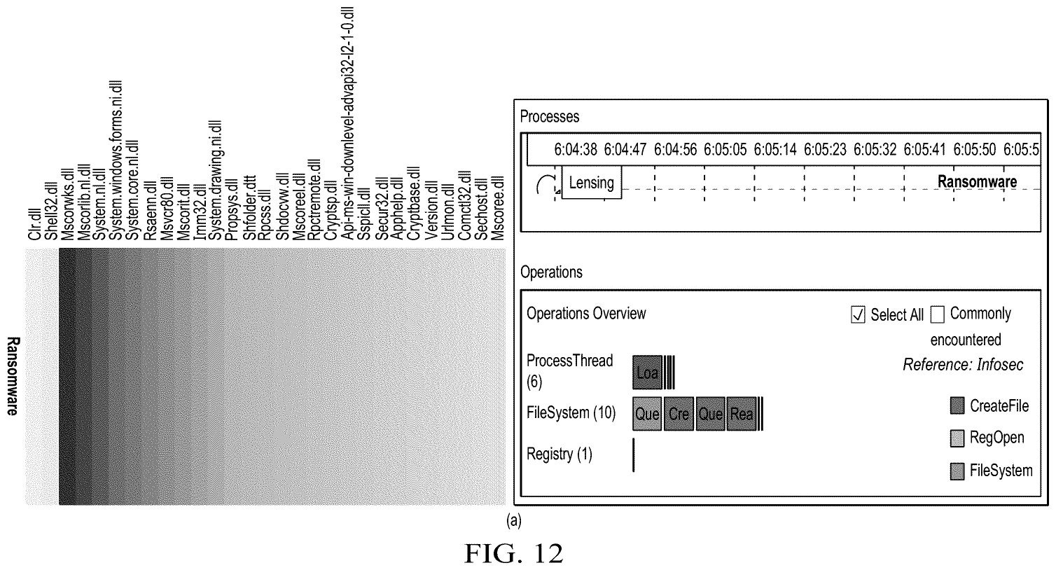

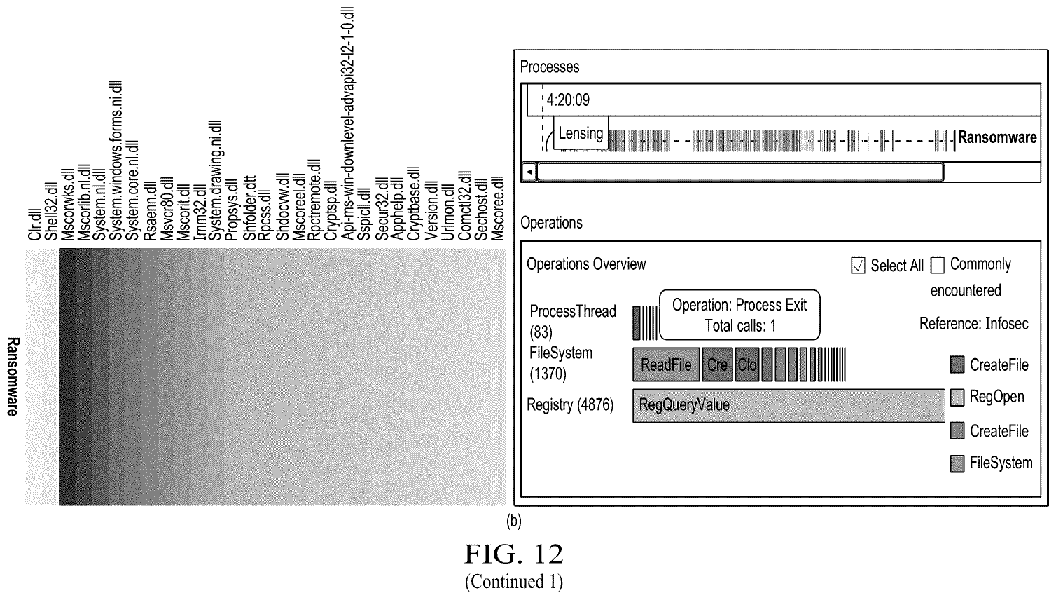

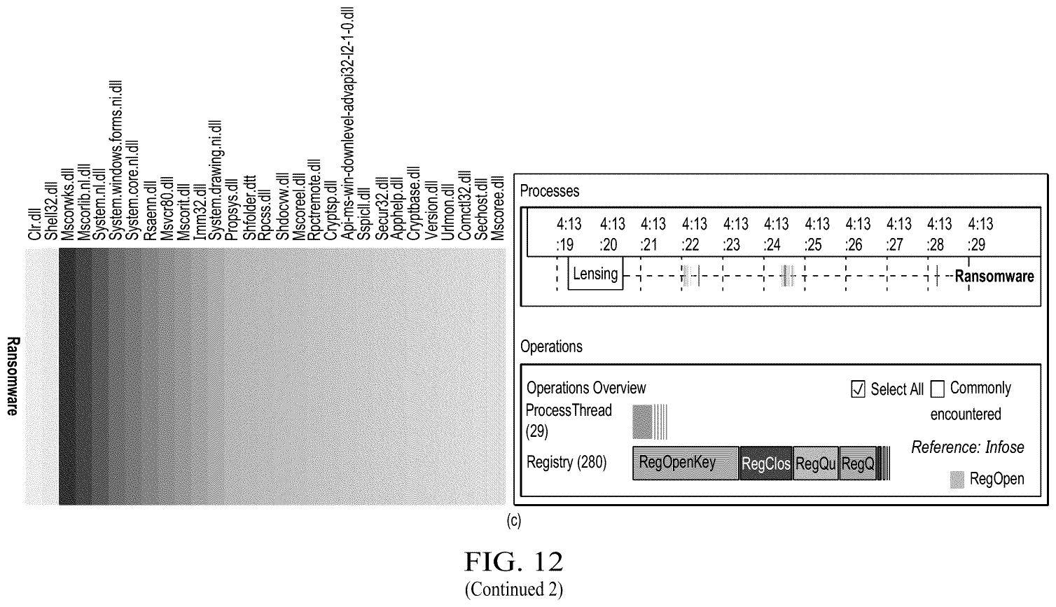

The ransomware samples were collected under different Windows platforms and had their behaviors compared using MalView. FIG. 12 captures the behavior of the ransomware on Windows XP in panel (a), Windows 7 in panel (b), and Windows 10 in panel (c), respectively in accordance with one embodiment of the present disclosure.
The ransomware sample performs a large number of registry operations on both Windows 10 and 7; whereas, it accesses the registry just one time on Windows XP.
On Windows 10, the ransomware did not perform any file operations; whereas, Windows 7 shows many file activities. The Windows XP platform shows traces of a few file operations.
The DLL called by the ransomware remained almost unchanged for three platforms.
The upper right panel of the tool shows a time interval sequence of process, file, registry operations performed by the ransomware. Both Windows 10 and Windows XP show that the malicious PE executes sparsely; whereas, on Windows 7, it shows more consecutive operations.
The lower right panels show the statistics of commonly encountered and critical activities of the ransomware.

### B. Email Flooder

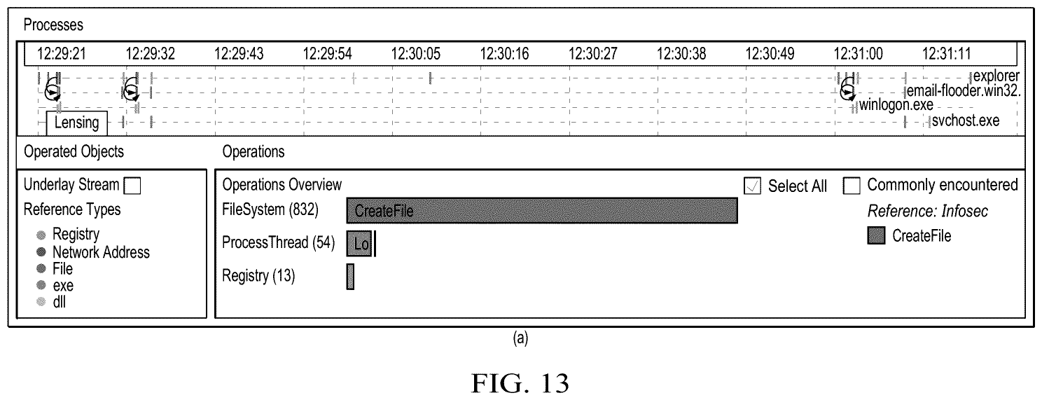

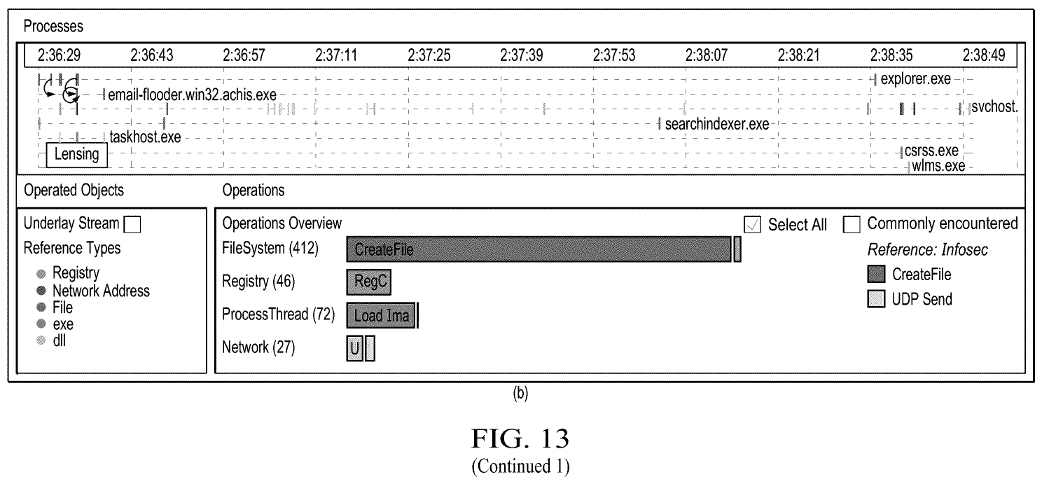

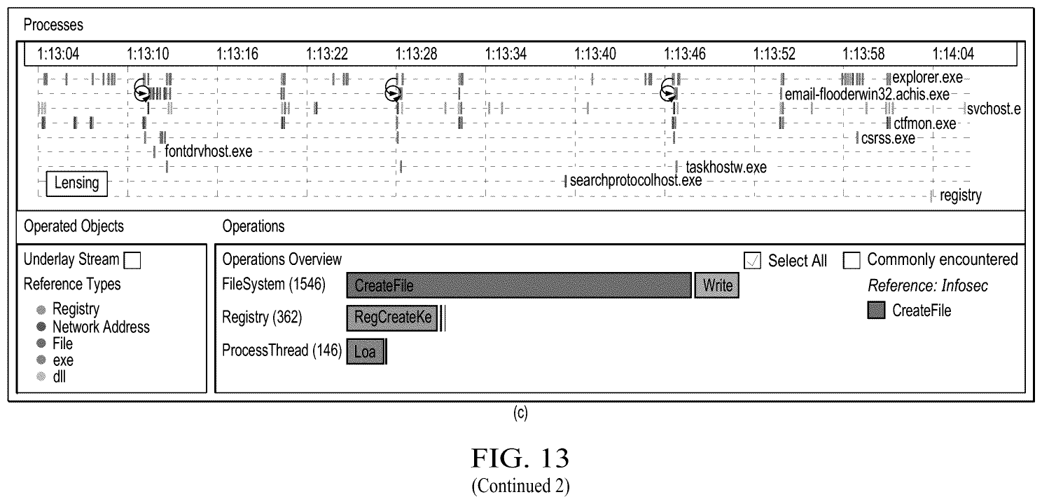

The “email flooder” malware was chosen to compare the visualization for this sample run in different platforms, including Windows XP in panel (a), Windows 7 in panel (b), and Windows 10 in panel (c), as depicted in FIG. 13 in accordance with one embodiment of the present disclosure. In particular, the output for Windows XP is simpler than the outputs produced by Windows 7 and 10. For example, the number of different processes for Windows XP is four vs. seven and nine for Windows 7 and 10, respectively. In addition, the total number of operations is much higher in Windows 10 than in Windows XP. It is observable that there is more information, including more processes, calls, dependencies, and activities in Windows 10 and 7 than XP. Since some of these pieces of information might be because of the Windows activities themselves and not the malware activities, tracking malware behavior in newer platforms might be more complicated.

### C. Behavioral Malware

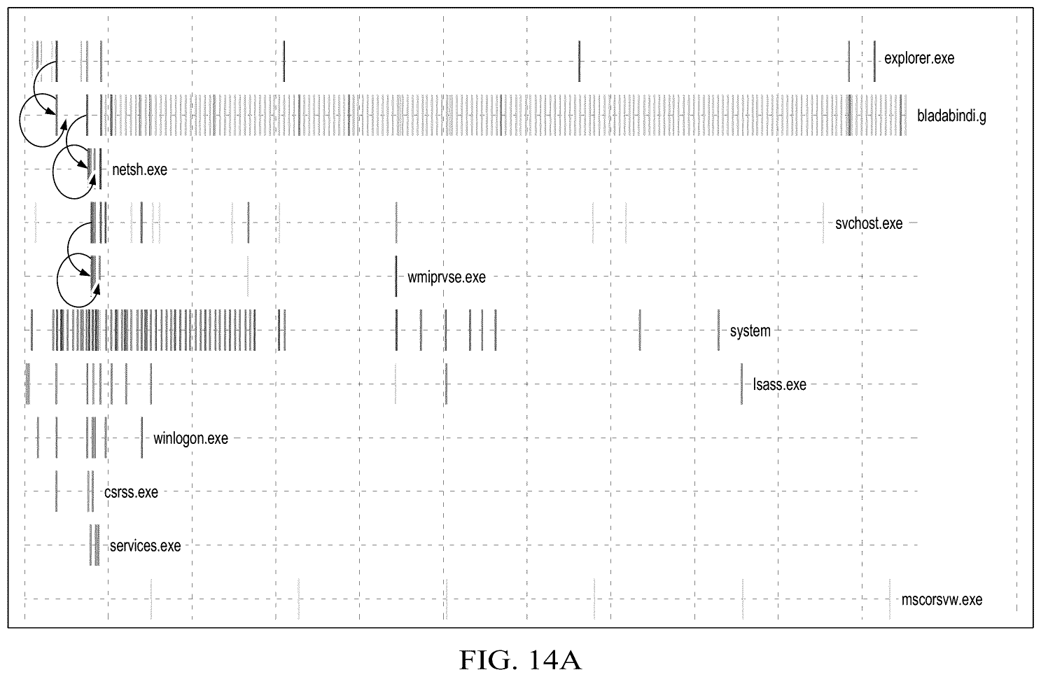

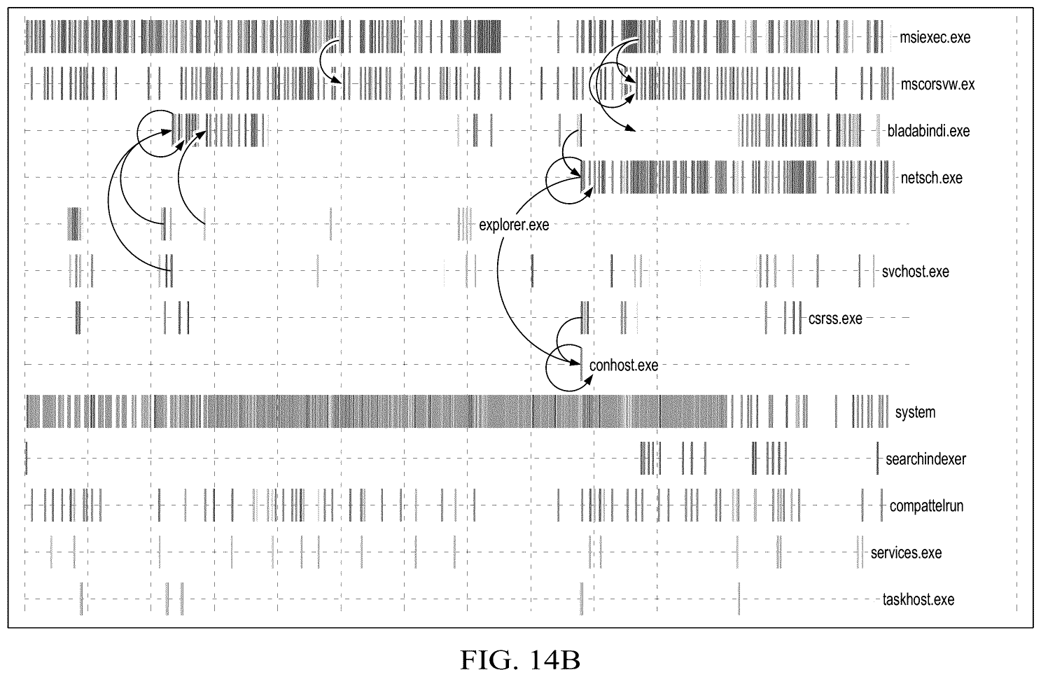

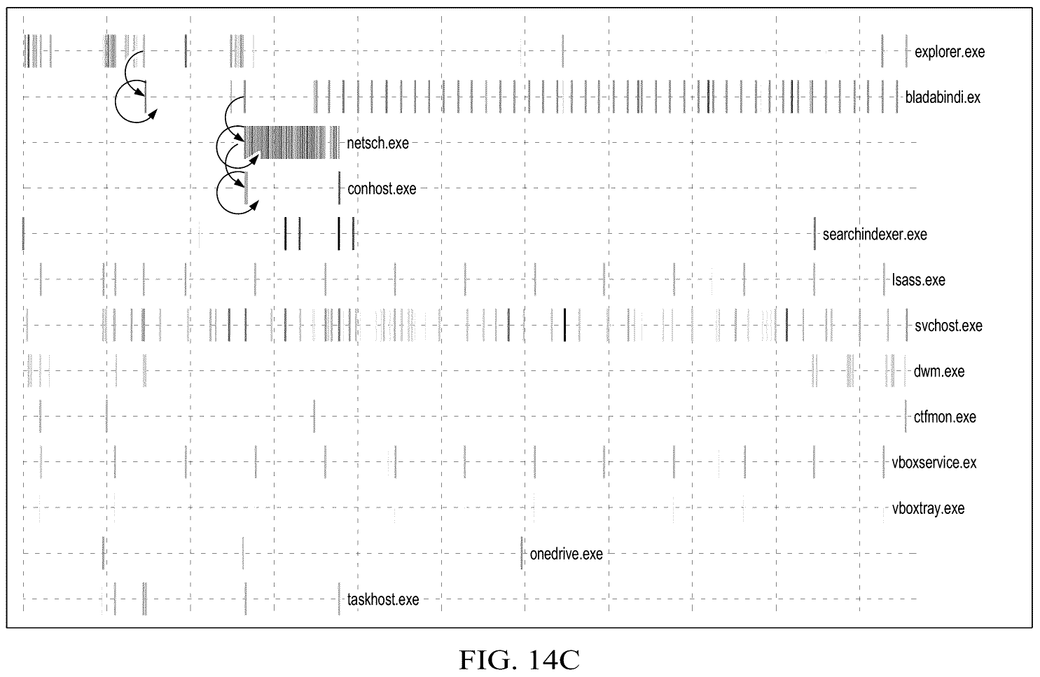

FIGS. 14A-C shows MalView views applied to Bladabindi malware executed on these three Windows operating systems: Windows XP in FIG. 14A, Windows 7 in FIG. 14B, and Windows 10 in FIG. 14C in accordance with one embodiment of the present disclosure. In general, more platform-related processes are being executed in the latter two operating systems in comparison to Windows XP. However, its suspicious activities remain the same. In all platforms, it first starts netsh.exe to modify firewall configuration and then sets the registry values to run itself.

### D. Patterns Across Platforms

One of the key features and benefits of employing visualization tools is to perform pattern detection and classification visually prior to delving into analytical approaches. MalView captures key features that are indicators for profiling classes or families of malware.

More specifically, using MalView it is possible to capture features such as volume of processes, registry activities, files manipulation and accesses, and network activities. As described below, these features are able to detect any “behavioral” patterns in the set of malware studied and thus enable us to classify them according to their dynamic behavior. Instead of trying to generate patterns of interest, in this study, we show how the analysis works based on malware behavior tracing, the kind of information it entails, and how the tool can enable analysts to quickly study the interaction of malware with system internals using selections, focus and context technique, and aggregations.

MalView focuses on the interactions of the malware program to other system's internal processes. While Procmon, as the data provider, brings detailed information into each of the processes running in the system, the interval and log activity captured may be subjective to the person behind the capturing execution. To focus on the time interval in which one can witness the most significant amount of malware activity to other system's internal processes, called busy interval, focus and context visualization technique was applied in MalView to support 1) close-up view for individual malware analysis and 2) standardization for malware comparison. To accommodate the context around the focal point, the interval was selected that satisfies either ensuring the equal paddings to the first and last interaction to the boundary of the interval or equal paddings to the peak of the area chart—where the highest amount of interactions are witnessed.

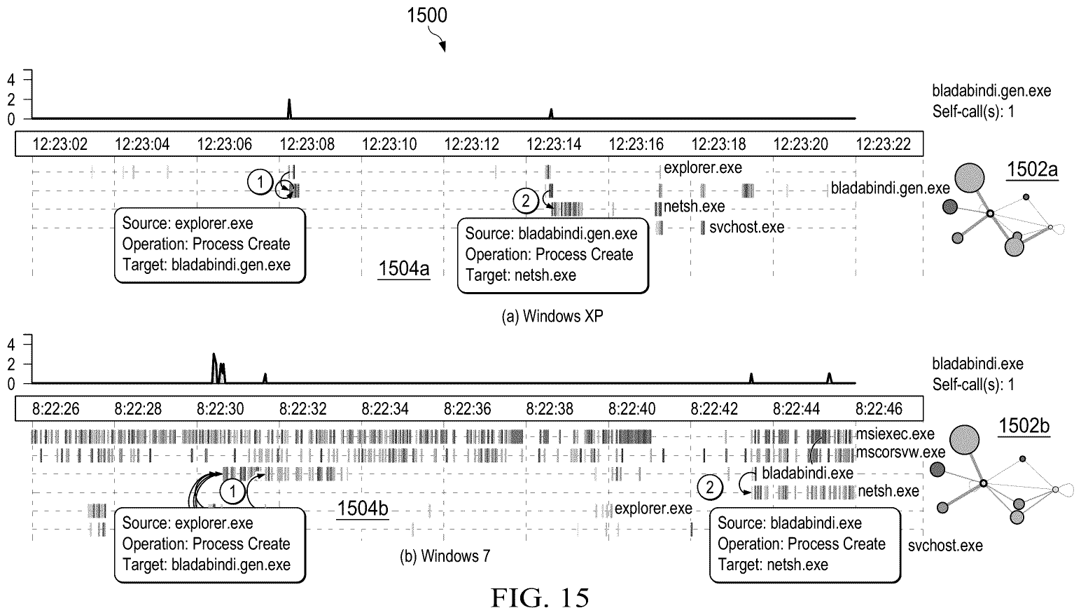

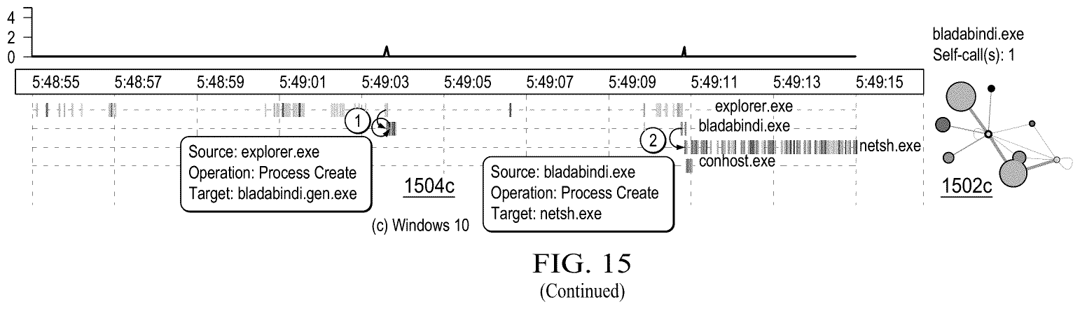

FIG. 15 shows patterns of Bladabindi malware behavior 1500 across platforms: (a) Windows XP, (b) Windows 7, and (c) Windows 10, all under focus and context technique with busy interval length of 20 seconds, are shown in accordance with one embodiment of the present disclosure. On the right end of FIG. 15 are the corresponding dependency graphs of the malware processes 1502a, 1502b and 1502c. By using mousing over an arc representing a function call in the panels 1504a, 1504b and 1504c, a user can observe the detailed information including type of operation, source and target processes as shown in windows. A recurring pattern observed from the bladabindi is the following sequence of calls: A ProcessCreate from explorer.exe to the malware, following by a ProcessCreate from the malware to netsh.exe. As shown in FIG. 5 and FIG. 7, different processes produce very different dependency connections in terms of topology, grouping and volume. However, as presented on the right end of FIG. 15, the dependencies of the three bladabindi malware processes across different platforms 1502a, 1502b and 1502c, demonstrate many similarities: the three biggest nodes that have the degree of one are all from registry (green), file (sand color), and dll (grey). For nodes with a degree of two-having connections with both bladabindi and netsh.exe, their categories are the same regardless of the running platforms. For further analysis, these patterns can serve as indicators for such classes of malware.

### VII. Malware Visualization Tools vs. MalView

This section compares the features offered by MalView with the ones offered by some other malware visualization tools, including Hybrid [38] and AnyRun [39]. First, each visualization tool is briefly reviewed and then its features are compared.

### A. AnyRun: Interactive Online Malware Sandbox

Funded in 2016 by a Russian security researcher, Alexey Lapshin, AnyRun [39] offers a free “interactive” sandbox tool for dynamic analysis of malware. The tool enables uploading a suspicious file and, in the meantime, interacting with the sandbox and thus with malware to trigger some functionalities or execute macros embedded into the uploaded file. AnyRun offers several key features, as follows:
The tool's main feature is the visualization of interactive graphs and tree structure for comprehending malware. The feature helps visually identify suspicious processes, determine the family of malicious activities and patterns, and highlight external files that are downloaded by the malware.
It also enables content analysis of different types of suspicious and malware files, including PCAP files (i.e., network activity dump).
The tool also performs network analysis with the goal of tagging suspicious events. It analyzes Hypertext Transfer Protocol (Secure) (HTTP(s)) requests and responses along with their headers.
The tool can be used as an educational and training tool to assist the security experts to understand the structure of attacks through Mitre Att&ck Mapping [40].
It enables opening web addresses (URLs) in different browsers and therefore helps in URL analysis and, more importantly, phishing attacks using various mainstream and supported browsers.

The tool generates a fine-format report for publication and sharing purposes. The professional-looking report consists of supporting screenshots, Process Behavior Graphs, indicators of being malicious/suspicious, and many other components.

### B. Hybrid: Automated Malware Analysis Service

Hybrid [38] is a free malware analysis tool that enables both static and dynamic analysis. It utilizes several analysis reports and sandbox tools, including Falcon Sandbox [41], a dynamic analysis framework. In addition to the dynamic analysis offered by Falcon Sandbox, Hybrid integrates some other anti-virus tools such as VirusTotal, OPSWAT Metadefender, SIEM systems, NSRL (i.e., white listing), TOR (e.g., avoiding external IP fingerprinting), Phantom, Thug Honey Client (e.g., URL exploit analysis), and Suricata (ETOpen/ETPro rules). The tool provides several useful analysis features such as:
Risk summary and verdict of being malicious or benign.
A good number of malicious/suspicious indicators.
A large set of network rules for intrusion detection and network analysis.
Integration with YARA [42] for rule-based pattern matching-based malware detection.
Analysis of a wide variety of files including binary samples and PCAP files.
Analysis of URLs for detection of phishing attacks.

### C. A Feature-Based Comparison

This section aims to highlight the key features of AnyRun [39] and Hybrid [38] in comparison with the features offered by MalView. The comparison is performed through the classification of features into 1) general features, 2) behavioral activities and dynamic analysis, 3) structure based and static analysis, and 4) network-level analysis. Table 1 lists the features classified into these four groups.

### 1) General Features

MalView offers not only comparatively similar features but also additional features that are unique to MalView. More precisely, the tool offers features such as 1) compliance with InfoSec classification with respect to malicious processors and indicators (Feature #4), and 2) simplification of visualization through filtering and focusing only a subset of processes for the analysis (Feature #5).

### 2) Behavioral Activities and Dynamic Analysis Features

The features related to dynamic analysis are considerably diverse. As a result, each analysis tool offers its own set of unique features. Given the fact that MalView mostly visualizes the output of Procmon [6], it is primarily a dynamic analysis tool. Depending on how the underlying malware visualization tool is implemented, most of these tools are able to visualize the “basic” sets of dynamic data captured through Procmon or similar utilities. For instance, as Table 1 shows, most of the behavioral features are visualizable by these three tools.

On of the major and key features that is unique to MalView is the exploration of “time dependencies between processes” (Features #15 and #16). The visualization of time and process dependencies are an important part of malware analysis in order to comprehend the nature of the underlying malware.

### 3) Signature-Based and Static Analysis

As stated earlier, MalView is primarily a visual analytics tool based on the output of the dynamic analysis of the underlying application or malware. As a result, it is less focused on visualizing static features of executable files. However, MalView is integrated with several static analysis tools, including VirusTotal, and thus is capable of capturing this information and visualizing them accordingly. VirusTotal is able to capture static information such as the size of header files, type of files, PE Specific, and other static and signature-based features. As a result, MalView can visualize all the information captured by VirusTotal and uses its API to retrieve this information and visualize them accordingly.

### 4) Network Level Analysis

Similar to signature-based and static analysis features, MalView is less focused on visualizing purely network-level features. However, given the strength of Procmon in capturing all related processes and events, MalView is capable of visualizing the network-level events and processes captured by Procmon and thus provides a process-level view on this network-level information.

### VIII. Related Work

The malware analysis methods can be broadly categorized into static vs. dynamic analysis [44]. Many of these approaches utilize visual representation to enable the analysts to visually capture general activities related to malware from a large number of data files or logs which are infeasible to digest in text or binary format [45].

### A. Signature-Based Features/Static Analysis

Panas [46] visualized software binaries in order to demonstrate malware samples. In their approach, they first disassemble the file to obtain the Abstract Syntax Tree (AST) and then provided the intermediate representation of the file by using ROSE [47], an open-source compiler. Visualizing the signature of a set of different malware families, they were able to show the changes in different versions of a malware family. Also utilizing visualizations in dynamic malware analysis, Grégio et al. [45] proposed a solution with two interactive visualization tools. The two visualization prototypes are a timeline with a magnifier and a spiral view of the malicious activities. The first tool provides analysts with views of the malware activities over time. While the time selection for the x-axis is similar to ours (and many others), the uses of colors and what is to be presented in the y-axis are different. They used the y-axis to represent activities and colors to different processes or services involved by the malware execution. Each event (an activity at a timestamp of an involved process) is presented by a circle connected by a line, which represents changes over time. This presentation leads to the visual cluttering issue, especially when malware does many different activities in a short time interval [48].

Gove et al. [49] presented their tool Similarity Evidence Explorer for Malware (SEEM), which compares a focal sample of malware with other malicious samples in the database. The malware features are grouped into nine categories, and feature similarities are visually presented in three ways: 1) histogram, 2) Venn diagram list, and 3) a feature matrix. The histogram utilizes the Jaccard similarity of the features of the focal sample with the other samples. In contrast, the Venn diagram is more granular and shows information of overlap, strict subset, and disjoint features. The feature matrix highlights the specific features present in the analyzed sample. Long et al. [50] proposed a versatile and instinctive technique to identify a given malware file from its image sets. The authors argued that the desktop icons are one effective social engineering attempt employed by some malware developers. The victim clicks on the icon resulting in the execution of the malware. Hence, comparing a new malware based on its image with a previously known malware database results in effective malware identification. Extracted greyscale malware images

are shown using a force-directed graph [15], [17], which is essentially a similarity network of sample malware images computed with the nearest neighbor index. The visualization tool shows hash values of the executable, and upon clicking on the values, it draws the similarity network graph, and it provides zooming functionalities for multiple hops of each node.

### B. Image-Based and Dynamic Analysis

While static analysis is computationally efficient, its performance could be impaired by packed or encrypted malware. On the other hand, dynamic analysis analyzes actual behaviors from the malware while it is running, so it is more efficient [51]. In their work [52], Shaid and Maarof proposed a method to generate images representing malware API calls. First, the API calls are monitored in the malware behavior capturing step. These calls are then sorted from malicious to less malicious. Finally, each API call is assigned a color depending on its maliciousness level. Similarly, Kancherla et al. [51] proposed to convert the malware into a gray-scale image called byteplot. They then used machine learning (ML) methods (e.g., Support Vector Machines) to analyze the low-level features (e.g., intensity and textures) extracted from the resulted images. Regarding ML approaches, LeDoux and Lakhotia [53] presented that ML has a natural fit with malware analysis, where ML operates by rapidly learning, discovering inherent patterns and similarities in the corpus.

With image-based malware classification, O'Shaughnessy [54] utilized the space-filling curves approach to formalize a scalable solution for classification ambiguity among anti-virus programs. Donahue [55] proposed another idea of using Markov Byte Plot [56] to convert Portable Executable (PE) files into truecolor (defined by red, green, and blue (RGB) color components) images that help to highlight the differences between the packed and unpacked malware. Another common approach is to convert malware PE or binary files into images and analyze the resulted images. There are various ways to turn the malware into images and different methods to analyze the produced images. For instance, Han et al., [57] proposed a three-step approach to analyze malware in this direction. First, the opcode sequences of the malware are extracted in Step 1. Step 2 generates an image with both width and height are of 2ⁿ, where n is a user-defined number. Next, this step applies a hash function, such as SimHash [58], to each of the extracted opcode sequences to generate a pixel with corresponding x-y position and RGB color. Finally, similarities between the resulted images are calculated in Step 3. In their extended version of this approach [44], they also incorporated dynamic analysis to filter for essential opcode sequences.

Miles et al. [59] presented VirusBattle, a system equipped with intelligence navigation and visualization to mine and to discover interrelationships between malware instances automatically. This system provides two primary analyses: 1) a program's dynamic trace tree and 2) a scalable method of discovering shared Computed Semantics artifacts among instances of malware. VirusBattle analyzes the interrelationships over many types of malware artifacts, including the binary, code, code semantics, dynamic behaviors, malware metadata. Shaid and Marrof [60] proposed the method of presenting the behavioral pattern of malicious files using a Hot-to-Cold color ramp. As the malware runs, the user-mode API calls are captured, then ordered and grouped based on their maliciousness. This behavior-to-color map of the malware helps visualize when and in which order a malware sample performs malicious activities during execution.

Besides software systems, research in hardware advancement has introduced many approaches that facilitate malware analysis to build a transparent dynamic analysis system. In terms of hardware virtualization extensions, Dinaburg et al. [61] proposed Ether, an application that remained transparent and defeated a large percentage of obfuscation tools. Later, Lengyel et al. [62] built DRAKVUF on a similar virtualization extensions approach and provided greater insight into the execution of the system to trace system execution for malware analysis.

This visual analytics approach in MalView can benefit the branch prediction in dynamic environment analysis in GoldenEye by Xu et al. [63] and the analysis of sequences of API calls in VECG by Alaeiyan et al. [64]. The interactive visual representations can expedite the process of proactively detecting environment-sensitive and context-based behaviors, where “human-in-the-loop” can accelerate early stopping and quickly capture patterns that emerged from the API call sequences.

### C. Hybrid (Static and Dynamic) Analysis

Most static approaches focus on comparing, clustering malware instances, or classifying if a new sample belongs to a known family of malware. For example, Paturi et al., [65] used Pythagoras tree to represent the similarities in codes between malware. The similarity metrics might be “Cosine similarity” or “Normalized Compression Distance.” The hierarchical structure of the Pythagoras tree is characterized as the distance between nodes at each lower depth of the tree is reduced by \sqrt{2}/2. Thus, the tree helps bring malware with higher similarities into clusters as leaf nodes with shorter distances stay close to one another.

Anderson et al. [66] presented a malware classification system that works based on the combination of static and dynamic features. For static feature extraction, they used three sources, including 1) the binary file, 2) the disassembled binary, and 3) the control flow graph of the disassembled binary file. For dynamic feature extraction, they used dynamic instruction sequence and the dynamic call sequence. They tested their system using a large malware dataset and achieved 98.07% accuracy with the combined static and dynamic features. They also achieved a 96.14% accuracy by using only static features. Yoo [67] designed the visualization based on the belief that malicious content in an executable file has a unique feature called SOM (Self-Organizing Map). By calculating the SOM and visualizing a specific executable file, the potential portion of the malicious content can be determined, and by checking the generated pattern, the malware family can be detected.

Saxe et al. [68] developed an interactive visualization system for comparing malware samples in a dataset using the extracted features. Based on the presence of the system call sequence, the similarity matrix for the malware dataset is generated. This system also provides a comparison view among malware samples based on their malicious activity. On mobile computing platforms such as Android devices, Jenkins and Cai [69], [70] explored Inter-Component Communications (ICC) via interactive visual explorations, showing thorough ICC comprehension and security vulnerability inspection, revealing the malicious behaviors that were normally hidden to users.

### D. Visualization Tools and Analysis

Analyzing malware through visual behaviors has been studied with the aim to observe the overall flow of a program, discover malicious patterns, and quickly assess the nature of the malware sample [5], [71]. Wagner et al. [72] proposed KAMAS, a knowledge-assisted visualization system for behavior-based malware analysis, which visualizes API call sequences gathered during the execution of malicious software. The Applicant's approach aligns with this direction, but the focus is shifted on the analysis side with different malware families and the influence of operating systems on malware behavior. In particular, the design decisions and techniques in MalView are applied in the malware analysis domain and derived from visualization principles for time-series data, which is the collection of observations through repeated measurements over time, including but not limited to numerical, geolocation, and text data [73], [74], [75]. Using Ether [61] as the monitoring platform, Quist and Liebrock [76] propose a directed graph structure of all the basic blocks of an executable with a navigable interface to explore the code structure. Treemaps and thread graphs are also visualization techniques that show usefulness in detecting maliciousness of software and in classifying malicious behavior [77]. The classification decisions can be supported by the visual analytics solution provided by Angelini et al. [78] to provide the user a better understanding of such decisions and the possibility of changing the classification results. Visual analytics approach, when combined with predictive analysis, can project potential threats or detect malicious attacks for securing efficient manufacturing automation [79].

Conti et al. [80] designed a system for file analysis with these features: 1) Analyze undocumented file format, 2) Audit files for vulnerabilities, 3) Compare files, 4) Crack, Cryptanalysis, and Forensic analysis, 5) Identify unknown file format, 6) Malware analysis and 7) Reporting. Their system is an extension to the hex editor and consists of both textual and graphical visualization. Quist and Liebrock [76] developed a tool called VERA (Visualization of Executables for Reversing and Analysis) that can be used for visualizing the structure and flow of an executable file, including memory reads and writes. Later, they extended their work [81] by adding more reverse engineering tools and providing more testing case studies in detail.

Trinius et al. [77] used two different approaches for malware visualization. They first generated an XML file containing dynamic analysis information of the malware sample using CWSandbox [82], including 1) loaded system libraries, 2) outgoing and incoming network connections, and accessed or manipulated registry keys. Using the XML output, they visualized the key feature using two techniques: “treemaps” and “thread graphs”. They argue that these two methods are complementary and, using these two visual representations, can effectively help detect the malicious behavior of the given malware and identify the malware family. They tested their proposed approach by executable and nonexecutable (PDF format) malware samples.

Gregio and Santos [83] developed an interactive timeline tool for visualizing dynamic malware behavior using various techniques [48]. They ran the given malware in a controlled environment and captured its behavior using a modified version of BehEMOT [84] (a malware behavior monitoring tool). They captured high-level activities such as file write and delete, process creation and termination, registry reads and writes, mutexes and network operations, and system calls using System Service Dispatch Table (SSDT) hooking, which operates at the kernel level. In addition, they used identification labels provided by VirusTotal [23].

An interactive visualization tool called Malware Vis is introduced by Zhou et al. [48] for malware dynamic analysis with a concentration on network traces including the total number of packets, size of the transmission, number of streams, and the packet trace's duration. They ran the malware in a controlled environment and captured these network traces by using packet sniffer software, where the output packet capture (PCAP) files were used for visualization. They used table views and shape views for representing the features that allow the user to browse, filter, and compare different types of malware. Cappers et al. [85] also utilize PCAP to discover the patterns in traffic to explore the intrusive behavior from malware activities.

### IX. Conclusion

This disclosure introduces MalView, an interactive visualization platform for hybrid analysis and diagnosis of malware. This approach first represents the behavioral properties of the major malware classes (such as Trojan or backdoor), aiming to capture the common visual signatures of these malicious applications. MalView implements a web-based prototype for demonstrating this approach to analyzing 60 malware samples from seven different classes. The behavior aspects of these malware files are captured using Process Monitor (i.e., Procmon [6] on three different platforms (Windows XP, Windows 7, and Windows 10). The functionality and features offered by MalView are designed and developed based on a thorough literature review and a comparison with the state-of-the-art malware analysis tools, including AnyRun and Hybrid. In order to have better insight regarding the features offered by MalView, a feature table is presented in which MalView is compared with AnyRun and Hybrid analysis tools. The feature comparison is performed based on four classes of features. The feature table demonstrates that MalView comparatively implements most of the features offered by the other two tools. In addition, the time and processed dependencies, the key features of MalView, are implemented in the prototype, making the analysis more thorough. Given the ability to process, visualize and analyze the system activities and put them into a comprehensive view, MalView can serve as an informative and potential interest to developers, engineers, and practitioners outside the laboratory.

There are several lines of research that can be explored through visual analytics when complemented by conventional static and dynamic analysis: The early detection of zero-day vulnerability and malware is a grand challenge. There are several machine learning-based approaches for addressing this problem [1], [53]. With the capability of visual analytics facilitating explainable machine learning [86], [87], applying visual analytics techniques to detecting and analyzing unknown and zero-day malware is an interesting research approach that can be explored using MalView. On of the key features of MalView is its features in demonstrating time and process dependencies that occurred during static and dynamic analysis. Additional applications may include modeling malware behavior through recurrent neural networks on the visual signatures and then predicting malware behaviors or even classifying suspicious programs into a particular class of malware. For example, modeling malware samples through genome alignments and then modeling the malware classification or detection problem through deoxyribonucleic acid (DNA) or sequence matching approaches. The sequence matching might be useful in capturing the core malicious functionalities of obfuscated malware. The obfuscation techniques employed by the obfuscating tools often follow similar patterns, and thus one would expect the control-flow graphs produced for all these obfuscated malicious applications share fully or partially the same core. MalView offers a visual analytic approach to spot these similar patterns in the execution traces. Once a section of the underlying execution trace is identified as obfuscated, it can be ignored by the user of MalView and then enables the users to focus on other parts of the malware in order to comprehend it. A second approach would be to employ existing de-obfuscated tools to de-obfuscate the malware under investigation (MUI) and then let Procmon generate the de-obfuscated traces of execution and processes.

### X. Additional Exemplary embodiments

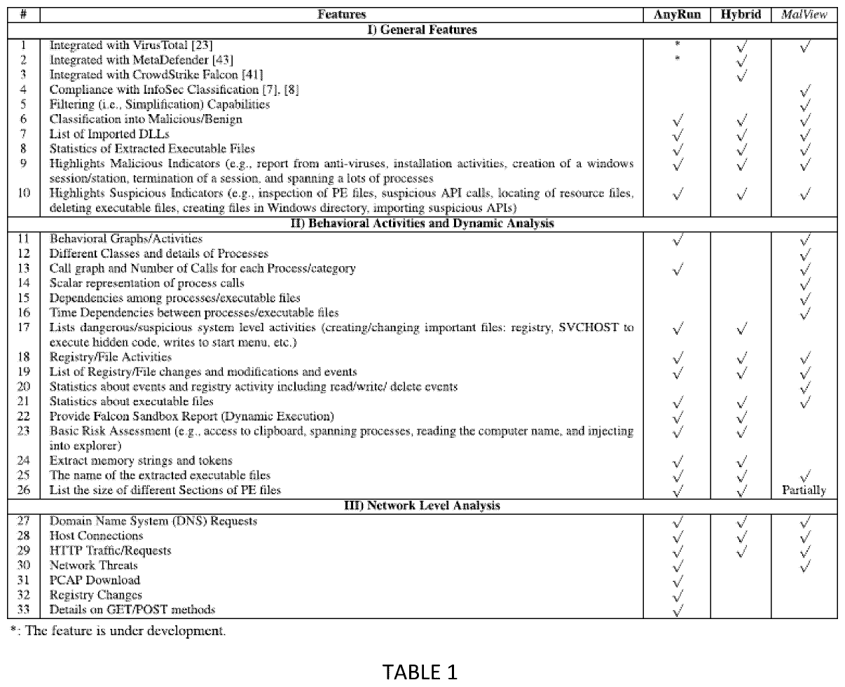

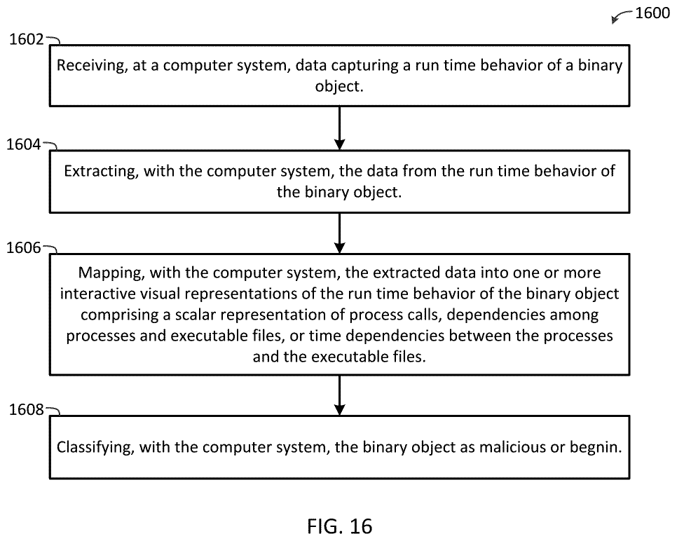

Now referring to FIG. 16, a method 1600 in accordance with one embodiment of the present disclosure is shown. Receiving, at a computer system, data capturing a run time behavior of a binary object in block 1602. Extracting, with the computer system, the data from the run time behavior of the binary object in block 1604. Mapping, with the computer system, the extracted data into one or more interactive visual representations of the run time behavior of the binary object comprising a scalar representation of process calls, dependencies among processes and executable files, or time dependencies between the processes and the executable files in block 1606. Classifying, with the computer system, the binary object as malicious or benign in block 1608.

In one aspect, the method further comprises identifying an intention and a location of a malicious payload in the binary object. In another aspect, the method further comprises analyzing an unknown malware within the object code by recognizing one or more unusual signatures or behaviors. In another aspect, the method further comprises generating one or more rules and signatures for fully-automated malware detection systems. In another aspect, the method further comprises identifying one or more of the following: one or more indicators of compromise and malicious activities; one or more system components that are affected, tampered or damaged by the object code; how the object code functions and infects the computer system; a primary target of the object code; one or more suspicious events that occurred on a network; and an impact on the host system and its registry. In another aspect, the data capturing the run time behavior of the binary object comprises an interaction of the binary object with the host system with respect to one or more of a file system, a registry, a network, a process and a process profile. In another aspect, the method further comprises selecting the data capturing the run time behavior of the binary object. In another aspect, extracting the data from the run time behavior of the binary object comprises processing the data into a time series data and a dependency data. In another aspect, the one or more interactive visual representation of the run time behavior of the binary object further comprises: an activity overview; a network visualization; or a libraries call. In another aspect, the method further comprises zooming, with the computer system, one of the one or more interactive visual representations of the run time behavior of the binary object. In another aspect, classifying, with the computer system, the binary object as malicious or benign further comprises classifying, with the computer system, the binary object as malicious, suspicious, undetected or harmless. In another aspect, the object code contains one or more of a remote access Trojan, a Trojan, a backdoor, a ransomware, an email flooder, a behavioral malware, and a hacktool malware. In another aspect, the method further comprises: executing the binary object on a host system; and logging the data capturing the run time behavior of the binary object during execution of the binary object into a file. In another aspect, the executing and logging steps are performed by a data provider. In another aspect, the host system comprises a sandboxed system. In another aspect, the data capturing the run time behavior of the binary object comprises one or more execution traces. In another aspect, the method further comprises: filtering out one or more first functions by default system operations; or filtering out one or more second functions that are not commonly encountered by malware. In another aspect, the method further comprises: receiving an output of an anti-virus tool using an application programming interface; and incorporating the output into the one or more interactive visual representations of the run time behavior of the binary object.

In another embodiment of the present disclosure, a non-transitory computer readable medium containing a set of instructions that, when executed by a processor, cause the processor to: receive data capturing a run time behavior of a binary object; extract the data from the run time behavior of the binary object; map the extracted data into one or more interactive visual representations of the run time behavior of the binary object comprising a scalar representation of process calls, dependencies among processes and executable files, or time dependencies between the processes and the executable files; and classify the binary object as malicious or benign.

In one aspect, further comprising causing the processor to identify an intention and a location of a malicious payload in the binary object. In another aspect, further comprising causing the processor to analyze an unknown malware within the object code by recognizing one or more unusual signatures or behaviors. In another aspect, further comprising causing the processor to generate one or more rules and signatures for fully-automated malware detection systems. In another aspect, further comprising causing the processor to identify one or more of the following: one or more indicators of compromise and malicious activities; one or more system components that are affected, tampered or damaged by the object code; how the object code functions and infects the computer system; a primary target of the object code; one or more suspicious events that occurred on a network; and an impact on the host system and its registry. In another aspect, the data capturing the run time behavior of the binary object comprises an interaction of the binary object with the host system with respect to one or more of a file system, a registry, a network, a process and a process profile. In another aspect, further comprising causing the processor to select the data capturing the run time behavior of the binary object. In another aspect, extracting the data from the run time behavior of the binary object comprises processing the data into a time series data and a dependency data. In another aspect, the one or more interactive visual representation of the run time behavior of the binary object further comprises: an activity overview; a network visualization; or a libraries call. In another aspect, further comprising causing the processor to zoom one of the one or more interactive visual representations of the run time behavior of the binary object. In another aspect, causing the processor to classify the binary object as malicious or benign further comprises causing the processor to classify the binary object as malicious, suspicious, undetected or harmless. In another aspect, the object code contains one or more of a remote access Trojan, a Trojan, a backdoor, a ransomware, an email flooder, a behavioral malware, and a hacktool malware. In another aspect, further comprising causing the processor to: execute the binary object on a host system; and log the data capturing the run time behavior of the binary object during execution of the binary object into a file. In another aspect, the executing and logging steps are performed by a data provider. In another aspect, the host system comprises a sandboxed system. In another aspect, the data capturing the run time behavior of the binary object comprises one or more execution traces. In another aspect, further comprising causing the processor to: filter out one or more first functions by default system operations; or filter out one or more second functions that are not commonly encountered by malware. In another aspect, further comprising causing the processor to: receive an output of an anti-virus tool using an application programming interface; and incorporate the output into the one or more interactive visual representations of the run time behavior of the binary object.

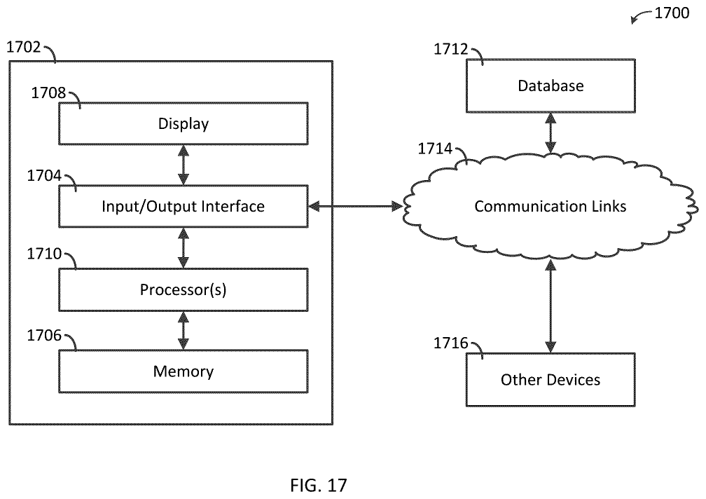

Now referring to FIG. 17, a block diagram of a computer system 1700 in accordance with one embodiment of the present disclosure is shown. An apparatus 1702 includes an input/output interface 1704, a memory 1706, a display 1708 communicably coupled to the input/output interface 1704, and one or more processors 1710 communicably coupled to the input/output interface 1704 and the memory 1706. Note that the apparatus 1702 may include other components not specifically described herein. The memory 1706 can be local, remote or distributed. Likewise, the one or more processors 1710 can be local, remote or distributed. Moreover, the apparatus 1702 may include database 1712 or be communicably coupled to the database 1712 via one or more communication links 1714. As a result, the database 1712 can be local, remote or distributed. The input/output interface 1704 can be any mechanism for facilitating the input and/or output of information (e.g., web-based interface, touchscreen, keyboard, mouse, display, printer, etc.) Moreover, the input/output interface 1704 can be a remote device communicably coupled to the one or more processors 1710 via one or more communication links 1714 (e.g., network(s), cable(s), wireless, satellite, etc.). The one or more communication links 1714 can communicably couple the apparatus 1702 to other devices 1716 (e.g., databases, remote devices, etc.). The system 1700 can be used to perform any of the processes and methods described herein. For example, the one or more processors 1710 receive data capturing a run time behavior of a binary object, extract the data from the run time behavior of the binary object, map the extracted data into one or more interactive visual representations of the run time behavior of the binary object comprising a scalar representation of process calls, dependencies among processes and executable files, or time dependencies between the processes and the executable files, and classify the binary object as malicious or benign.

In one aspect, the one or more processors identify an intention and a location of a malicious payload in the binary object. In another aspect, the one or more processors analyze an unknown malware within the object code by recognizing one or more unusual signatures or behaviors. In another aspect, the one or more processors generate one or more rules and signatures for fully-automated malware detection systems. In another aspect, the one or more processors identify one or more of the following: one or more indicators of compromise and malicious activities; one or more system components that are affected, tampered or damaged by the object code; how the object code functions and infects the computer system; a primary target of the object code; one or more suspicious events that occurred on a network; and an impact on the host system and its registry. In another aspect, the data capturing the run time behavior of the binary object comprises an interaction of the binary object with the host system with respect to one or more of a file system, a registry, a network, a process and a process profile. In another aspect, the one or more processors select the data capturing the run time behavior of the binary object. In another aspect, the one or more processors extract the data from the run time behavior of the binary object comprises the one or more processors process the data into a time series data and a dependency data. In another aspect, the one or more interactive visual representation of the run time behavior of the binary object further comprises: an activity overview; a network visualization; or a libraries call. In another aspect, the one or more processors zoom one of the one or more interactive visual representations of the run time behavior of the binary object. In another aspect, the one or more processors classify the binary object as malicious or benign further comprises the one or more processors classify the binary object as malicious, suspicious, undetected or harmless. In another aspect, the object code contains one or more of a remote access Trojan, a Trojan, a backdoor, a ransomware, an email flooder, a behavioral malware, and a hacktool malware. In another aspect, the one or more processors: execute the binary object on a host system; and log the data capturing the run time behavior of the binary object during execution of the binary object into a file. In another aspect, the executing and logging steps are performed by a data provider. In another aspect, the host system comprises a sandboxed system. In another aspect, the data capturing the run time behavior of the binary object comprises one or more execution traces. In another aspect, the one or more processors: filter out one or more first functions by default system operations; or filter out one or more second functions that are not commonly encountered by malware. In another aspect, the one or more processors: receive an output of an anti-virus tool using an application programming interface; and incorporate the output into the one or more interactive visual representations of the run time behavior of the binary object.

It is understood that particular embodiments described herein are shown by way of illustration and not as limitations of the invention. The principal features of this invention can be employed in various embodiments without departing from the scope of the invention. Those skilled in the art will recognize or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited features, elements, components, groups, integers, and/or steps, but do not exclude the presence of other unstated features, elements, components, groups, integers and/or steps. In embodiments of any of the compositions and methods provided herein, “comprising” may be replaced with “consisting essentially of” or “consisting of”. As used herein, the term “consisting” is used to indicate the presence of the recited integer (e.g., a feature, an element, a characteristic, a property, a method/process step or a limitation) or group of integers (e.g., feature(s), element(s), characteristic(s), property(ies), method/process steps or limitation(s)) only. As used herein, the phrase “consisting essentially of” requires the specified features, elements, components, groups, integers, and/or steps, but do not exclude the presence of other unstated features, elements, components, groups, integers and/or steps as well as those that do not materially affect the basic and novel characteristic(s) and/or function of the claimed invention.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as still having the required characteristics and capabilities of the unmodified feature. In general, but subject to the preceding discussion, a numerical value herein that is modified by a word of approximation such as “about” may vary from the stated value by at least +1, 2, 3, 4, 5, 6, 7, 10, 12 or 15%.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

To aid the Patent Office, and any readers of any patent issued on this application in interpreting the claims appended hereto, applicants wish to note that they do not intend any of the appended claims to invoke paragraph 6 of 35 U.S.C. § 112, U.S.C. § 112 paragraph (f), or equivalent, as it exists on the date of filing hereof unless the words “means for” or “step for” are explicitly used in the particular claim.

For each of the claims, each dependent claim can depend both from the independent claim and from each of the prior dependent claims for each and every claim so long as the prior claim provides a proper antecedent basis for a claim term or element.

### REFERENCES

H. N. Nguyen, F. Abri, V Pham, M. Chatterjee, A. S. Namin, T. Dang, “MalView: Interactive visual analytics for comprehending malware behavior” IEEE Access, Sep. 19, 2022, vol. 10, pp. 99909-99930 doi: 10.1109/ACCESS.2022.3207782.
[1] F. Abri, S. Siami-Namini, M. A. Khanghah, F. M. Soltani, and A. S. Namin, “Can machine/deep learning classifiers detect zero-day malware with high accuracy?” in Proc. IEEE Int. Conf. Big Data (Big Data), December 2019, pp. 3252-3259.
[2] C. Guarnieri. (2019). Cuckoo Sandox: Automated Malware Analysis. [Online]. Available: cuckoosandbox.org/
[3] V. T. Nguyen, A. S. Namin, and T. Dang, “MalViz: An interactive visualization tool for tracing malware,” in Proc. 27th ACM SIGSOFT Int. Symp. Softw. Test. Anal. New York, NY, USA: ACM, July 2018, pp. 376-379.
[4] W. Casey, J. Havrilla, C. Hines, L. Metcalf, and A. Shelmire, “Sparse representation modeling for software corpora,” in Results of SEI Line-Funded Exploratory New Starts Projects. Pittsburgh, PA, USA: Carnegie Mellon Univ., 2012, p. 43.
[5] M. Wagner, F. Fischer, R. Luh, A. Haberson, A. Rind, D. A. Keim, W. Aigner, R. Borgo, F. Ganovelli, and I. Viola, “A survey of visualization systems for malware analysis,” in Proc. Eurographics Conf. Vis. (EuroVis) STARs, 2015, pp. 105-125.
[6] Microsoft. Process Monitor—Windows Sysinternals—Microsoft Docs. Accessed: Nov. 29, 2020. [Online]. Available: docs.microsoft. com/en-us/sysinternals/downloads/procmon
[7] Infosec. (2015). Windows Functions in Malware Analysis Cheat Sheet Part 1. Accessed: Jun. 5, 2019. [Online]. Available: resources.infosecinstitute.com/topic/windows-functions-in-malware-analysis-cheatsheet-part-1/
[8] Infosec. (2015). Windows Functions in Malware Analysis Cheat Sheet Part 2. Accessed: Jun. 5, 2019. [Online]. Available: resources.infosecinstitute.com/topic/windows-functions-in-malware-analysis-cheatsheet-part-2/
[9] M. E. Russinovich and A. Margosis. Windows Sysinternals Administrator's Reference, 1st ed. Redmond, WA, USA: Microsoft Press, 2011.
[10] M. Bostock, V. Ogievetsky, and J. Heer, “D³ data-driven documents,” IEEE Trans. Vis. Comput. Graph., vol. 17, no. 12, pp. 2301-2309 December 2011.
[11] R. Amar, J. Eagan, and J. Stasko, “Low-level components of analytic activity in information visualization,” in Proc. IEEE Symp. Inf. Vis. (INFOVIS), October 2005, pp. 111-117.
[12] B. Shneiderman, “The eyes have it: A task by data type taxonomy for information visualizations,” in The Craft of Information Visualization. Amsterdam, The Netherlands: Elsevier, 2003, pp. 364-371.
[13] J. M. Spring, L. B. Metcalf, and E. Stoner, “Correlating domain registrations and DNS first activity in general and for malware,” Nat. Phys. Lab., Securing Trusting Internet Names (SATIN), Teddington, U.K., 2011.
[14] T. McGraw, “Glitch style visualization of disrupted neuronal connectivity in Parkinson's disease,” in Proc. IEEE VIS Arts Program (VISAP), October 2017, pp. 1-8.
[15] N. V. Nguyen, H. N. Nguyen, J. Hass, and T. Dang, “JobNet: 2D and 3D visualization for temporal and structural association in high-performance computing system,” in Proc. Int. Symp. Vis. Comput. Cham, Switzerland: Springer, 2021, pp. 210-221.
[16] H. N. Nguyen and T. Dang, “EQSA: Earthquake situational analytics from social media,” in Proc. IEEE Conf. Vis. Analytics Sci. Technol. (VAST), October 2019, pp. 142-143.
[17] H. Van, H. N. Nguyen, R. Hewett, and T. Dang, “HackerNets: Visualizing media conversations on Internet of Things, big data, and cybersecurity,” in Proc. IEEE Int. Conf. Big Data (Big Data), December 2019, pp. 3293-3302.
[18] Microsoft. How Microsoft Identifies Malware and Potentially Unwanted Applications. Accessed: Nov. 29, 2020. [Online]. Available: docs.microsoft.com/en-us/windows/security/threat-protection/intelligence/criteria
[19] Microsoft. Malware Names. Accessed: Nov. 29, 2020. [Online]. Available: docs.microsoft.com/en-us/windows/security/threatprotection/intelligence/malware-naming
[20] Microsoft. Cyberthreats, Viruses, and Malware—Microsoft Security Intelligence. Accessed: Dec. 24, 2019. [Online]. Available: mircosoft.com/en-us/wdsi/threats
[21] Check Point Software Technologies Ltd. Blog. (2019). October 2018's Most Wanted Malware: For the First Time, Remote Access Trojan Reaches Top 10 Threats. [Online]. Available: blog.checkpoint.com/2018/11/13/october-2018s-mostwanted-malware-for-the-first-time-remote-access-trojan-reaches-topthreats-cryptomining/
[22] Corvus Forensics. (2019). Virus Share. [Online]. Available: https://virusshare.com/
[23] H. Sistemas. (2019). Virustotal Public API V2.0. [Online]. Available: virustotal.com/en/documentation/public-api/
[24] Kaspersky. What is a Trojan Virus?—Definition. Accessed: 2019. [Online]. Available: usa.kaspersky.com/resource-center/threats/trojans
[25] Microsoft Security Intelligence. Trojan: Win32/MultiInjector.C. Accessed: May 24, 2022. [Online]. Available: Microsoft.com/en-us/wdsi/threats/malware-encyclopedia-description?Name=Trojan:Win32/MultiInjector.C
[26] Imperva. Backdoor Attack—What is Backdoor?. Accessed 2019. [Online]. Available: imperva.com/learn/application-security/backdoor-shell-attack/
[27] G. O'Gorman and G. McDonald Ransomware: A Growing Menace. Tempe, AZ, USA: Symantec.
[28] Malwarebytes Labs. (2021). Kaseya Hijacked, Thousands Attacked by Revil, Fix Delayed Again. [Online]. Available: malwarebytes.com/blog/news/2021/07/shutdown-kaseya-vsa-servers-now-amidst-cascading-revil-attack-against-msps-clients
[29] W. Zamora. (2017). The State of Ransomware Among SMBS. [Online]. Available: blog.malwarebytes.com
[30] Microsoft Security Intelligence. Behavior: Win32/Bladabindi.gen. Accessed: Dec. 24, 2019. [Online]. Available: Microsoft.com/en-us/wdsi/threats/malware-encyclopedia-description?Name=Behavior: Win32/Bladabindi.gen&threatId=−2147281575
[31] Microsoft Security Intelligence. Behavior: Win32/Vawtrak.A. Accessed: Dec. 24, 2019. [Online]. Available: wdsi-filesubmission. trafficmanager.net/en-us/wdsi/threats/malware-encyclopedia-description?Name=Behavior:Win32/Vawtrak.A&threatId=−2147280787
[32] Microsoft Security Intelligence. Behavior: Win32/Teerac.B. Accessed: Dec. 24, 2019. [Online]. Available: wdsi-filesubmission. trafficmanager.net/en-us/wdsi/threats/malware-encyclopedia-description?Name=Behavior:Win32/Teerac.B&threatId=−2147277970
[33] Microsoft Security Intelligence. Behavior: Win32/MultiInjector. Accessed: Dec. 24, 2019. [Online]. Available: wdsi-filesubmission. trafficmanager.net/en-us/wdsi/threats/malware-encyclopedia-description?Name=Behavior:Win32/MultiInjector&threatId=−2147325646
[34] D. V. Pham, A. Syed, and M. N. Halgamuge, “Universal serial bus based software attacks and protection solutions,” Digit. Invest., vol. 7, nos. 3-4, pp. 172-184, 2011.
[35] S. Kumar, L. Madhavan, M. Nagappan, and B. Sikdar, “Malware in pirated software: Case study of malware encounters in personal computers,” in Proc. 11th Int. Conf. Availability, Rel. Secur. (ARES), 2016, pp. 423-427.
[36] Microsoft Security Intelligence. HackTool: Win32/Mailpassview. Accessed: Dec. 24, 2019. Microsoft.com/en-us/wdsi/threats/malware-encyclopedia-description?Name=HackTool:Win32/Mailpassview &threatId=−2147395884
[37] Quick Heal. Golroted Malware Uses Web Browser Weakness to Steal Sensitive Information. Accessed: Dec. 24, 2019. [Online]. Available: dlupdate.quickheal.com/documents/others/quick_heal_golroted_malware_threat_report_june_2015.pdf
[38] Payload Security. Free Automated Malware Analysis Service—Hybrid Analysis. Accessed: 2019. [Online]. Available: hybridanalysis.com/
[39] ANY.RUN LLC. ANY.RUN—Interactive Online Malware Sandbox. Accessed: 2019. [Online]. Available: any.run/
[40] MITRE Corporation. Mitre Att&ck Framework. Accessed: 2019. [Online]. Available: attack.mitre.org/
[41] Crowdstrike. Automated Malware Analysis & Sandbox: Falcon Sandbox. Accessed: 2019. [Online]. Available: crowdstrike.com/
[42] Victor Manuel Alvarez. Yara: The Pattern Matching Swiss Knife for Malware Researchers. Accessed: 2019. [Online]. Available: virustotal.github.io/yara/
[43] OPSWAT Inc., (2020). Metadefender Cloud. [Online]. Available: metadefender.opswat.com/
[44] K. Han, B. Kang, and E. G. Im, “Malware analysis using visualized image matrices,” Sci. World J., vol. 2014 July 2014, Art. no. 132713.
[45] A. R. A. Grégio, A. O. C. Baruque, V. M. Afonso, D. S. O. F. Filho, P. L. D. Geus, M. Jino, and R. D. C. D. Santos, “Interactive, visual-aided tools to analyze malware behavior,” in Proc. Int. Conf. Comput. Sci. Appl. Berlin, Germany: Springer-Verlag, 2012, pp. 302-313.
[46] T. Panas, “Signature visualization of software binaries,” in Proc. 4th ACM Symp. Softw. Visuallization (SoftVis), New York, NY, USA: ACM, 2008, pp. 185-188.
[47] Lawrence Livermore National Laboratory. Rose Compiler: Program Analysis and Transformation. Accessed 2010. [Online]. Available: rosecompiler.org/
[48] W. Zhuo and Y. Nadjin, “Malwarevis: Entity-based visualization of malware network traces,” in Proc. 9th Int. Symp. Vis. Cyber Secur. New York, NY, USA: ACM, 2012, pp. 41-47.
[49] R. Gove, J. Saxe, S. Gold, A. Long, and G. Bergamo, “Seem: A scalable visualization for comparing multiple large sets of attributes for malware analysis,” in Proc. 11th Workshop Vis. Cyber Secur., 2014, pp. 72-79.
[50] A. Long, J. Saxe, and R. Gove, “Detecting malware samples with similar image sets,” in Proc. 11th Workshop Vis. Cyber Secur., November 2014, pp. 88-95.
[51] K. Kancherla and S. Mukkamala, “Image visualization based malware detection,” in Proc. IEEE Symp. Comput. Intell. Cyber Secur. (CICS), April 2013, pp. 40-44.
[51] S. Z. M. Shaid and M. A. Maarof, “Malware behaviour visualization,” Jurnal Teknologi, vol. 70, no. 5, pp. 1-9, 2014.
[52] C. LeDoux and A. Lakhotia, “Malware and machine learning,” in Intelligent Methods for Cyber Warfare. Cham, Switzerland: Springer, 2015, pp. 1-42.
[54] S. O'Shaughnessy, “Image-based malware classification: A space filling curve approach,” in Proc. IEEE Symp. Vis. Cyber Secur. (VizSec), October 2019, pp. 1-10.
[55] J. Donahue, A. Paturi, and S. Mukkamala, “Visualization techniques for efficient malware detection,” in Proc. IEEE Int. Conf. Intell. Secur. Informat., June 2013, pp. 289-291.
[56] K. Kancherla, J. Donahue, and S. Mukkamala, “Packer identification using byte plot and Markov plot,” J. Comput. Virology Hacking Techn., vol. 12, no. 2, pp. 101-111, May 2016.
[57] K. Han, J. H. Lim, and E. G. Im, “Malware analysis method using visualization of binary files,” in Proc. Res. Adapt. Convergent Syst. (RACS), 2013, pp. 317-321.
[58] M. S. Charikar, “Similarity estimation techniques from rounding algorithms,” in Proc. 34th Annu. ACM Symp. Theory Comput., 2002, pp. 380-388.
[59] C. Miles, A. Lakhotia, C. LeDoux, A. Newsom, and V. Notani, “VirusBattle: State-of-the-art malware analysis for better cyber threat intelligence,” in Proc. 7th Int. Symp. Resilient Control Syst. (ISRCS), August 2014, pp. 1-6.
[60] S. Z. Mohd Shaid and M. A. Maarof, “Malware behavior image for malware variant identification,” in Proc. Int. Symp. Biometrics Secur. Technol. (ISBAST), August 2014, pp. 238-243.
[61] A. Dinaburg, P. Royal, M. Sharif, and W. Lee, “Ether: Malware analysis via hardware virtualization extensions,” in Proc. 15th ACM Conf. Comput. Commun. Secur. (CCS), 2008, pp. 51-62.
[62] T. K. Lengyel, S. Maresca, B. D. Payne, G. D. Webster, S. Vogl, and A. Kiayias, “Scalability, fidelity and stealth in the DRAKVUF dynamic malware analysis system,” in Proc. 30th Annu. Comput. Secur. Appl. Conf., December 2014, pp. 386-395.
[63] Z. Xu, J. Zhang, G. Gu, and Z. Lin, “Goldeneye: Efficiently and effectively unveiling malware's targeted environment,” in Proc. Int. Workshop Recent Adv. Intrusion Detection. Cham, Switzerland: Springer, 2014, pp. 22-45.
[64] M. Alaeiyan, S. Parsa, and M. Conti, “Analysis and classification of context-based malware behavior,” Comput. Commun., vol. 136, pp. 76-90, February 2019.
[65] A. Paturi, M. Cherukuri, J. Donahue, and S. Mukkamala, “Mobile malware visual analytics and similarities of attack toolkits (malware gene analysis),” in Proc. Int. Conf. Collaboration Technol. Syst. (CTS), May 2013, pp. 149-154.
[66] B. Anderson, C. Storlie, and T. Lane, “Improving malware classification: Bridging the static/dynamic gap,” in Proc. 5th ACM Workshop Secur. Artif. Intell. (AISec). New York, NY, USA: ACM, 2012, pp. 3-14.
[67] I. Yoo, “Visualizing Windows executable viruses using self-organizing maps,” in Proc. ACM Workshop Vis. Data Mining Comput. Secur. (VizSEC/DMSEC). New York, NY, USA: ACM, 2004, pp. 82-89.
[68] J. Saxe, D. Mentis, and C. Greamo, “Visualization of shared system call sequence relationships in large malware corpora,” in Proc. 9th Int. Symp. Vis. Cyber Secur. (VizSec). New York, NY, USA: ACM, 2012, pp. 33-40.
[69] J. Jenkins and H. Cai, “Dissecting Android inter-component communications via interactive visual explorations,” in Proc. IEEE Int. Conf. Softw. Maintenance Evol. (ICSME), September 2017, pp. 519-523.
[70] J. Jenkins and H. Cai, “ICC-inspect: Supporting runtime inspection of Android inter-component communications,” in Proc. 5th Int. Conf. Mobile Softw. Eng. Syst., May 2018, pp. 80-83.
[71] M. Wagner, W. Aigner, A. Rind, H. Dornhackl, K. Kadletz, R. Luh, and P. Tavolato, “Problem characterization and abstraction for visual analytics in behavior-based malware pattern analysis,” in Proc. 11th Workshop Vis. Cyber Secur., 2014, pp. 9-16.
[72] M. Wagner, A. Rind, N. Thür, and W. Aigner, “A knowledge-assisted visual malware analysis system: Design, validation, and reflection of KAMAS,” Comput. Secur., vol. 67, pp. 1-15, June 2017.
[73] T. Dang, N. H. Nguyen, and V. Pham, “WordStream: Interactive visualization for topic evolution,” in EuroVis 2019—Short Papers, J. Johansson, F. Sadlo, and G. E. Marai, Eds. Geneva, Switzerland: The Eurographics Association, 2019.
[74] T. Dang, V. Pham, H. N. Nguyen, and N. V. T. Nguyen, “AgasedViz: Visualizing groundwater availability of Ogallala aquifer, USA,” Environ. Earth Sci., vol. 79, no. 5, pp. 1-12, March 2020.
[75] H. N. Nguyen, C. M. Trujillo, K. Wee, and K. A. Bowe, “Interactive qualitative data visualization for educational assessment,” in Proc. 12th Int. Conf. Adv. Inf. Technol., New York, NY, USA: ACM, June 2021, pp. 1-9.
[76] D. A. Quist and L. M. Liebrock, “Visualizing compiled executables for malware analysis,” in Proc. 6th Int. Workshop Vis. Cyber Secur., 2009, pp. 27-32.
[77] P. Trinius, T. Holz, J. Gobel, and F. C. Freiling, “Visual analysis of malware behavior using treemaps and thread graphs,” in Proc. 6th Int. Workshop Vis. Cyber Secur., October 2009, pp. 33-38.
[78] M. Angelini, L. Aniello, S. Lenti, G. Santucci, and D. Ucci, “The goods, the bads and the Uglies: Supporting decisions in malware detection through visual analytics,” in Proc. IEEE Symp. Vis. Cyber Secur. (VizSec), October 2017, pp. 1-8.
[79] D. D. Le, V. Pham, H. N. Nguyen, and T. Dang, “Visualization and explainable machine learning for efficient manufacturing and system operations,” Smart Sustain. Manuf. Syst., ASTM Int., West Conshohocken, PA, USA, Tech. Rep., 2019, vol. 3, no. 2, pp. 127-147, doi: 10.1520/SSMS20190029.
[80] G. Conti, E. Dean, M. Sinda, and B. Sangster, “Visual reverse engineering of binary and data files,” in Visualization for Computer Security, J. R. Goodall, G. Conti, and K.-L. Ma, Eds. Berlin, Germany: Springer, 2008, pp. 1-17.
[81] D. A. Quist and L. M. Liebrock, “Reversing compiled executables for malware analysis via visualization,” Inf. Vis., vol. 10, no. 2, pp. 117-126, 2011.
[82] CWSandbox. Cwsandbox—Automated Online Malware Analysis. Accessed: 2020. [Online]. Available: cwsandbox.org/
[83] R. A. A. Gregio and D. C. R. Santos, “Visualization techniques for malware behavior analysis,” in Proc. SPIE, vol. 8019, E. M. Carapezza, Ed. July 2011, pp. 9-17.
[84] A. R. Grégio, D. S. F. Filho, V. M. Afonso, R. D. Santos, M. Jino, and P. L. D. Geus, “Behavioral analysis of malicious code through network traffic and system call monitoring,” Proc. SPIE, vol. 8059 May 2011, Art. no. 80590O.
[85] B. C. Cappers, P. N. Meessen, S. Etalle, and J. J. V. Wijk, “Eventpad: Rapid malware analysis and reverse engineering using visual analytics,” in Proc. IEEE Symp. Vis. Cyber Secur. (VizSec), October 2018, pp. 1-8.
[86] T. Dang, H. Van, H. Nguyen, V. Pham, and R. Hewett, “Deep Vix: Explaining long short-term memory network with high dimensional time series data,” in Proc. 11th Int. Conf. Adv. Inf. Technol., July 2020, pp. 1-10.
[87] T. Dang, H. N. Nguyen, and N. V. T. Nguyen, “VixLSTM: Visual explainable LSTM for multivariate time series,” in Proc. 12th Int. Conf. Adv. Inf. Technol., June 2021, pp. 1-5.

What is claimed is:

1. A method, comprising:
receiving, at a computer system, data capturing a run time behavior of a binary object;
extracting, with the computer system, the data from the run time behavior of the binary object;
mapping, with the computer system, the extracted data into one or more interactive visual representations of the run time behavior of the binary object comprising a scalar representation of process calls, dependencies among processes and executable files, or time dependencies between the processes and the executable files; and
classifying, with the computer system, the binary object as malicious or benign.

2. The method of claim 1, further comprising identifying an intention and a location of a malicious payload in the binary object.

3. The method of claim 1, further comprising analyzing an unknown malware within the object code by recognizing one or more unusual signatures or behaviors.

4. The method of claim 1, further comprising generating one or more rules and signatures for fully-automated malware detection systems.

5. The method of claim 1, further comprising identifying one or more of the following:
one or more indicators of compromise and malicious activities;
one or more system components that are affected, tampered or damaged by the object code;
how the object code functions and infects the computer system;
a primary target of the object code;
one or more suspicious events that occurred on a network; and
an impact on the host system and its registry.

6. The method of claim 1, wherein the data capturing the run time behavior of the binary object comprises an interaction of the binary object with the host system with respect to one or more of a file system, a registry, a network, a process and a process profile.

7. The method of claim 1, further comprising selecting the data capturing the run time behavior of the binary object.

8. The method of claim 1, wherein extracting the data from the run time behavior of the binary object comprises processing the data into a time series data and a dependency data.

9. The method of claim 1, wherein the one or more interactive visual representation of the run time behavior of the binary object further comprises:
an activity overview;
a network visualization; or
a libraries call.

10. The method of claim 1, further comprising zooming, with the computer system, one of the one or more interactive visual representations of the run time behavior of the binary object.

11. The method of claim 1, wherein classifying, with the computer system, the binary object as malicious or benign further comprises classifying, with the computer system, the binary object as malicious, suspicious, undetected or harmless.

12. The method of claim 1, wherein the object code contains one or more of a remote access Trojan, a Trojan, a backdoor, a ransomware, an email flooder, a behavioral malware, and a hacktool malware.

13. The method of claim 1, further comprising:
executing the binary object on a host system; and
logging the data capturing the run time behavior of the binary object during execution of the binary object into a file.

14. The method of claim 13, wherein the executing and logging steps are performed by a data provider.

15. The method of claim 13, wherein the host system comprises a sandboxed system.

16. The method of claim 13, wherein the data capturing the run time behavior of the binary object comprises one or more execution traces.

17. The method of claim 13, further comprising:
filtering out one or more first functions by default system operations; or
filtering out one or more second functions that are not commonly encountered by malware.

18. The method of claim 1, further comprising:
receiving an output of an anti-virus tool using an application programming interface; and
incorporating the output into the one or more interactive visual representations of the run time behavior of the binary object.

19. A non-transitory computer readable medium containing a set of instructions that, when executed by a processor, cause the processor to:
receive data capturing a run time behavior of a binary object;
extract the data from the run time behavior of the binary object;
map the extracted data into one or more interactive visual representations of the run time behavior of the binary object comprising a scalar representation of process calls, dependencies among processes and executable files, or time dependencies between the processes and the executable files; and
classify the binary object as malicious or benign.

20. A system comprising:
a database;
a memory; and
one or more processors communicably coupled to the database and the memory, wherein the one or more processors receive data capturing a run time behavior of a binary object, extract the data from the run time behavior of the binary object, map the extracted data into one or more interactive visual representations of the run time behavior of the binary object comprising a scalar representation of process calls, dependencies among processes and executable files, or time dependencies between the processes and the executable files, and classify the binary object as malicious or benign.
